(19) United States
(12) Patent Application Publication
(10) Pub. No.: US 2026/0230137 A1
(43) Pub. Date: Aug. 6, 2026

(54) METHODS AND PROCEDURES OF UPLINK TRANSMISSION FOR EFFICIENT UTILIZATION OF RESOURCES

(71) Applicant: InterDigital Patent Holdings, Inc., Wilmington, DE (US)

(72) Inventors: Mohammad Irfan, Chateauguay (CA); Afshin Haghighat, Ile-Bizard (CA); Loic Canonne-Velasquez, Dorval (CA); Moon IL Lee, Melville, NY (US); Omid Saatlou, Montreal (CA); Dylan Watts, Montreal (CA)

(73) Assignee: InterDigital Patent Holdings, Inc., Wilmington, DE (US)

(21) Appl. No.: 19/044,157

(22) Filed: Feb. 3, 2025

(51) Int. Cl. H04B 7/06; H04L 1/00; H04L 5/00

(52) U.S. Cl. CPC H04B 7/0626; H04B 7/0639; H04L 1/0008; H04L 5/0051

(57) ABSTRACT

A WTRU may be configured to efficiently utilize redundant resources in a first resource set by transmitting, in a second resource set, a larger number of reference symbols. The WTRU also may report CSIs with a lower code-rate. Based on association rules that provide an indication for utilizing redundant resources, the WTRU may efficiently utilize redundant resources by replacing zero padded bits in the first resource set with transmission parameters in the second resource set. Based on the association rules, the WTRU may dynamically determine a DMRS configuration, a code-rate, a modulation and coding scheme (MCS), and/or CSI quantization parameters.

### BACKGROUND

A rank value is associated with the assignment of resources a user equipment (UE) may receive from a base station. In existing systems, a base-station (BS) may allow a UE to select or determine a rank value and/or precoders based on an allowed set of rank value(s) and/or based on an allowed set of layer index(es). For example, using a radio resource control (RRC) bitmap the base station may indicate to the UE, the set of allowed rank values and/or the allowed layer index(es) that the UE can select when determining channel state information (CSI).

The BS may assign uplink resources to the UE for reporting uplink control information (UCI) or CSI. The UCI payload may depend on the selected rank value at the UE, the selected layer index(es) at the UE, the number of non-zero coefficients selected by the UE or other parameters. Thus, the BS is unaware of the actual CSI payload size that will be generated by the actual CSI determined at the UE. The BS therefore assigns resources to the UE that can fit the maximum UCI payload generated by the allowed rank values/entities. For example, assume that the BS allows rank values 1, 2, 3, and 4. The rank value 4 generates the maximum payload size. The assigned resources are such that they can fit a CSI payload generated by a rank value equal to 4.

When the UE determines a rank value that generates an actual payload size that is smaller as compared to the maximum payload in that case, the assigned uplink resources are more than enough for reporting the determined CSI. In such a case, the UE uses extra bits in the uplink payload so that all the assigned resources are being used for transmission. FIG. 2 is an example depiction of resources being used for bit-padding and CSI reporting. More specifically FIG. 2, depicts an example of the resources used for reporting the actual CSI, maximum CSI, and bit-padding. This method of bit padding redundant resource and transmitting padded bits using redundant resources is inefficient in terms of resource utilization.

### SUMMARY

As described herein, a user equipment (UE), also referred to as a wireless transmit/receive unit (WTRU), may be configured to efficiently utilize redundant resources. The WTRU may be configured to transmit a larger number of reference symbols and/or reporting channel state information (CSI) with a lower code rate (e.g., the ratio between the number of useful data bits and the total number of transmitted bits). The WTRU may be configured to utilize multi-step CSI reporting for efficient utilization of assigned uplink resource. The WTRU may be configured to send CSI report(s) at different time instance(s) to minimize wasting time and frequency resources. The WTRU may be configured to send assistance information for correction of assigned uplink (UL) resources. The WTRU may be configured to implement a rule to minimize uplink resources for CSI reporting in hybrid beamforming CSI.

An example WTRU may comprise a transceiver and a processor. The processor may be configured to receive, via the transceiver, configuration information. The configuration information may comprise first uplink transmission parameters, a first uplink resource set, second uplink transmission parameters, a second uplink resource set, and an indication of association rules. The processor may be configured to determine a size of a first channel state information (CSI) payload and a size of a second CSI payload. The processor may be configured to, based on a determination that the size of the first CSI payload is less than the size of the second CSI payload, determine third uplink transmission parameters based on the association rules. The processor may be configured to send, via resources indicated by the first uplink resource set, a first uplink transmission using the first uplink transmission parameters, wherein the first uplink transmission comprises the first CSI payload. The processor may be configured to send, via resources indicated by the second uplink resource set, a second uplink transmission using the third uplink transmission parameters, wherein the second uplink transmission comprises the second CSI payload. The processor may be configured to, based on a determination that the size of the first CSI payload is equal to or greater than the size of the second CSI payload, send, via the resources indicated by the second uplink resource set, the second uplink transmission using the second uplink transmission parameters, wherein the second uplink transmission comprises the second CSI payload.

The third uplink transmission parameters may comprise a reference signal configuration, a code-rate, and a set of CSI quantization parameters for sending the second uplink transmission. The reference signal configuration may comprise a Demodulation Reference Signal (DMRS) configuration. The first uplink transmission parameters may comprise a first reference signal configuration, a first code-rate, and a first set of CSI quantization parameters for sending the first uplink transmission. The second uplink transmission parameters may comprise a second reference signal configuration, a second code-rate, and a second set of CSI quantization parameters for sending the second uplink transmission when the size of the first CSI payload is equal to or greater than the size of the second CSI payload. The third uplink transmission parameters may comprise a third reference signal configuration, a third code-rate, and a third set of CSI quantization parameters for sending the second uplink transmission when the size of the first CSI payload is less than the size of the second CSI payload.

The processor may be configured to determine a number and locations of symbols of the third uplink transmission parameters based on the association rules. The size of the first CSI payload may be based on a first rank value. The size of the second CSI payload size may be based on a second rank value.

The processor may be configured to determine the first rank value and receive, via the transceiver, the second rank value. The third uplink transmission parameters may comprise a precoding matrix indicator (PMI). The processor may be configured to determine a number of bits for bit padding the third uplink transmission based on the association rules. The processor may be configured to determine a number of non-zero coefficients of the second uplink transmission based on the association rules.

An example method may be performed by a WTRU. The method may comprise receiving configuration information. The configuration information may comprise first uplink transmission parameters, a first uplink resource set, second uplink transmission parameters, a second uplink resource set, and an indication of association rules. The method may comprise determining a size of a first channel state information (CSI) payload and a size of a second CSI payload. The method may comprise, based on a determination that the size of the first CSI payload is less than the size of the second CSI payload, determining third uplink transmission parameters based on the association rules. The method may comprise sending, via resources indicated by the first uplink resource set, a first uplink transmission using the first uplink transmission parameters, wherein the first uplink transmission comprises the first CSI payload. The method may comprise sending, via resources indicated by the second uplink resource set, a second uplink transmission using the third uplink transmission parameters, wherein the second uplink transmission comprises the second CSI payload.

The third uplink transmission parameters may comprise a reference signal configuration, a code-rate, and a set of CSI quantization parameters for sending the second uplink transmission. The reference signal configuration may comprise a Demodulation Reference Signal (DMRS) configuration.

The first uplink transmission parameters may comprise a first reference signal configuration, a first code-rate, and a first set of CSI quantization parameters for sending the first uplink transmission. The second uplink transmission parameters may comprise a second reference signal configuration, a second code-rate, and a second set of CSI quantization parameters for sending the second uplink transmission when the size of the first CSI payload is equal to or greater than the size of the second CSI payload. The third uplink transmission parameters may comprise a third reference signal configuration, a third code-rate, and a third set of CSI quantization parameters for sending the second uplink transmission when the size of the first CSI payload is less than the size of the second CSI payload. The size of the first CSI payload may be based on a first rank value and the size of the second CSI payload size is based on a second rank value.

The method may comprise determining a number and locations of symbols of the third uplink transmission parameters based on the association rules. The method may comprise determining the first rank value and receiving the second rank value. The method may comprise determining a number of bits for bit padding the third uplink transmission based on the association rules. The method may comprise determining a number of non-zero coefficients of the second uplink transmission based on the association rules.

### BRIEF DESCRIPTION OF THE DRAWINGS

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 is an example depiction of resources being used for bit-padding and CSI reporting.

FIG. 3 is a an example flowchart depicting the WTRU behavior of channel state information (CSI) determination and reporting.

FIG. 4 is an example table (Table 1) of a first association rule for determining a third CSI configuration.

FIG. 5 is an example table (Table 2) of a second association rule for determining a second code rate.

FIG. 6 is an example table (Table 3) of a third association rule for determining a modulation and coding scheme (MCS).

FIG. 7 is an example depiction of time and/or frequency resource utilization for CSI and reference signal (RS) transmissions.

FIG. 8 is a depiction of an overview of example CSI reporting in multiple steps.

FIG. 9 is an example depiction of first and second sets of uplink resources.

FIG. 10 is an example depiction of using the determined rank value and previously reported rank values as implicit WTRU assistant information for efficient utilization of uplink (UL) resources.

FIG. 11 depicts a table (Table 4) of an example payload with the number of channel state information reference signal (CSI-RS) resources equal to 3 (Ks=3).

FIG. 12 is an example depiction of enhanced WTRU behavior in terms of CSI reporting when condition-A is satisfied.

### EXAMPLE NETWORKS FOR IMPLEMENTATION OF THE INVENTION

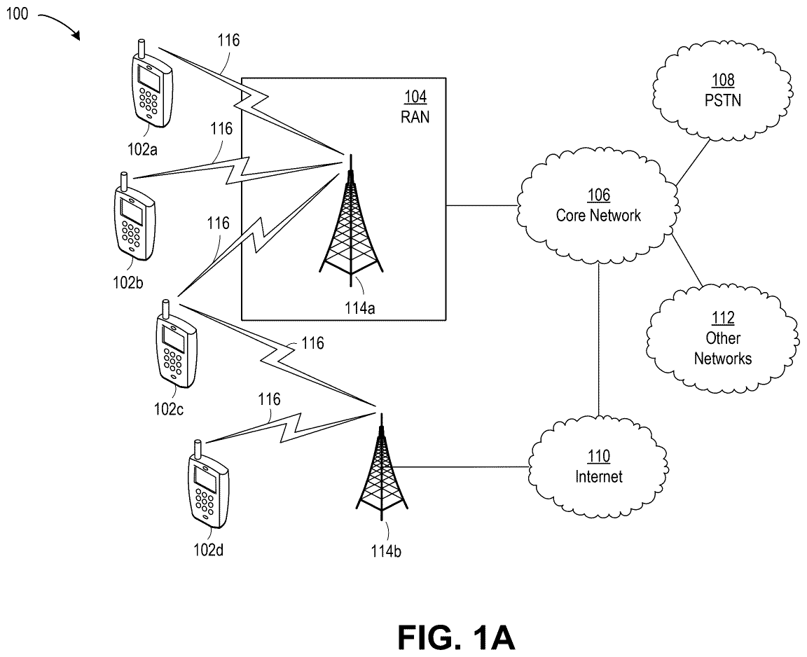

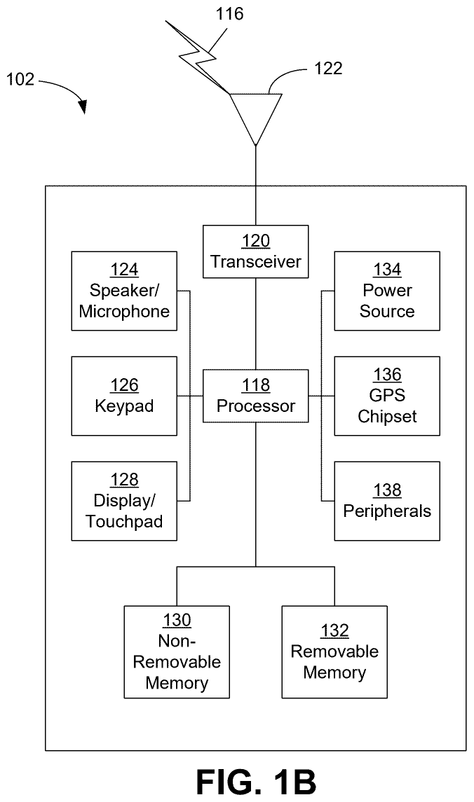

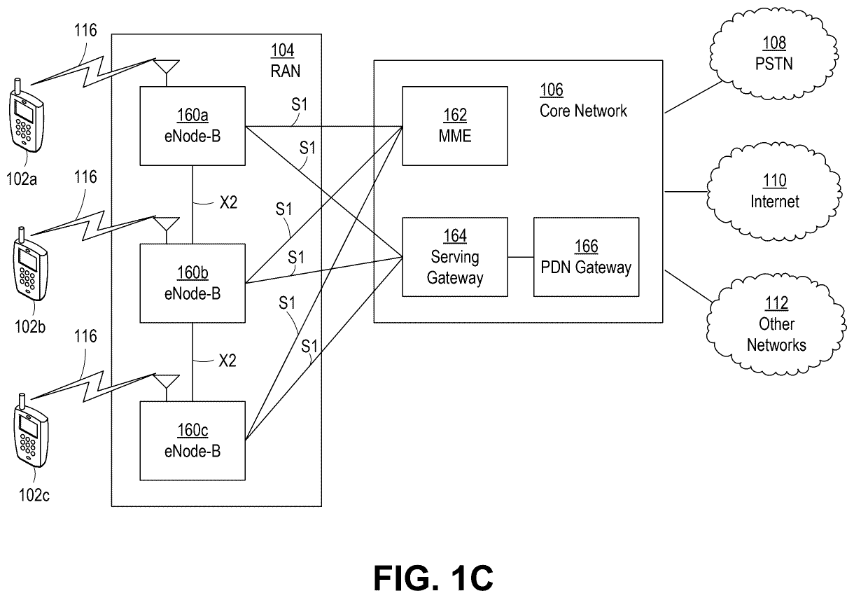

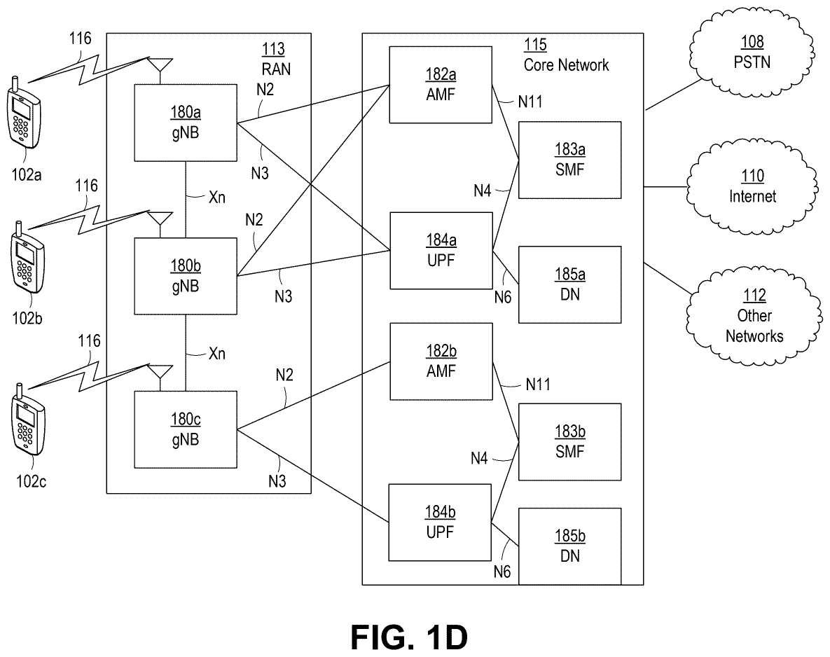

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As mentioned above, a base station (BS), also referred to herein a network node, may allow a WTRU to select or determine a rank value based on an allowed set of rank value(s) and/or based on an allowed set of layer index(es). A network node may include, for example, a BS, a gNodeB (gNB), an eNodeB (eNB), or the like. As described in more detail below, determination of a rank value may include determination of a rank indicator (RI), and/or a precoder, such as a precoding matrix indictor (PMI), or the like.

Using an RRC bitmap (e.g., RI-restriction, typeII-RI-Restriction, typeII-PortSelectionRI-Restriction, etc.), the BS may indicate to the WTRU the set of allowed rank values and/or the allowed layer index(es) that the WTRU can select when determining CSI. The BS may assign uplink resources, such as, for example physical uplink control channel (PUCCH) and/or physical uplink shared channel (PUSCH) resources to the WTRU for reporting UCI or CSI. The UCI payload may depend on the selected rank value at the WTRU, the selected layer index(es) at the WTRU, the number of non-zero coefficients selected by the WTRU, and/or other parameters, e.g., sub-band channel quality indicator (CQI) or wideband CQI, etc. Therefore, the BS is unaware of the actual CSI payload size that will be generated by the actual CSI determined at the WTRU. The BS therefore assigns resources to the WTRU that can fit the maximum UCI payload generated by the allowed rank values/entities. For example, assume that the gNB allows rank values 1, 2, 3, and 4, wherein the rank value 4 generates the maximum payload size. The assigned resources are such that they can fit a CSI payload generated by a rank value equal to 4.

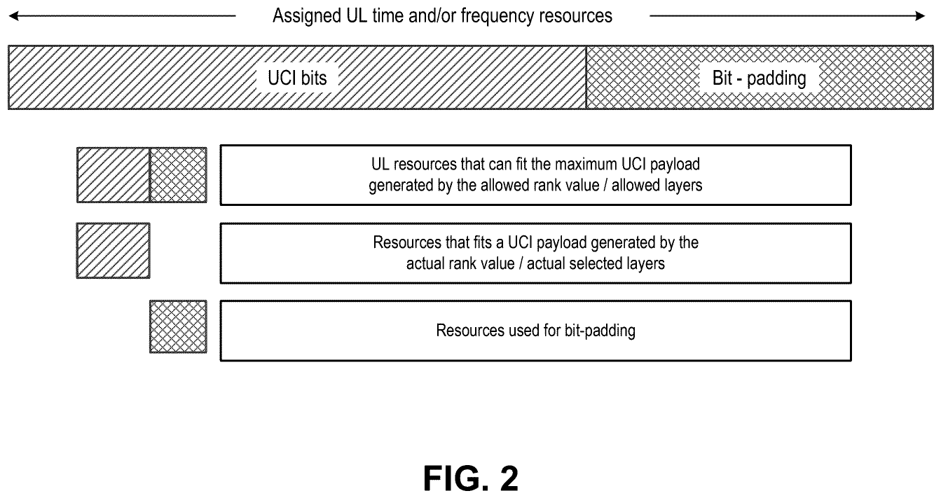

When the WTRU determines a rank value that generates an actual payload size (e.g., actual payload as described herein) that is smaller as compared to the maximum payload size (e.g., maximum CSI payload as described herein), the assigned uplink resources are more than enough for reporting the determined CSI. In such a case, the WTRU may use extra bits in the uplink payload so that all the assigned resources are being used for transmission. FIG. 2, depicts an example of the resources that may be used for reporting the actual CSI, maximum CSI, and bit-padding.

The following terminology is utilized herein.

Allowed rank value(s): The WTRU may receive one or more semi-static or dynamic configurations, such as radio resource control (RRC), medium access control-control element (MAC-CE), and/or downlink control information (DCI), and/or indicators that may indicate one or more rank values to the WTRU. The indicated rank values may be treated by the WTRU or used by the WTRU as the set of allowed rank values. Alternatively, the WTRU may treat the indicated rank values as disallowed rank values and the remaining rank values as the allowed rank value(s).

Allowed layer index(es): The WTRU may receive one or more semi-static or dynamic (e.g., RRC, MAC-CE, and/or DCI) configurations and/or indicators that may indicate one or more layer index(es) to the WTRU. The indicated layer index(es) may be treated by the WTRU or used by the WTRU as the set of allowed layers. Alternatively, the WTRU may treat the indicated layer index(es) as the set of disallowed layer index(es) and the remaining layer index(es) as the allowed layer(s).

Allowed entity or entities: The WTRU may receive one or more semi-static or dynamic (e.g., RRC, MAC-CE, and/or DCI) configurations and/or indicators that may indicate one or more entities, e.g., layer index(es), transmission and reception points (TRPs), panels, etc., to the WTRU. The indicated entities may be treated by the WTRU or used by the WTRU as the set of allowed entities. Alternatively, the WTRU may treat the indicated entity(es) index(es) as the set of disallowed entity(es) index(es) and the remaining entity(es) index(es) as the allowed entity(es).

Maximum uplink control information (UCI) and/or channel state information (CSI) payload: Throughout this disclosure, the term maximum UCI or CSI payload may refer to the following. One (e.g., a rank value) or more (e.g., a rank value, a number of non-zero coefficients, and a number of TRPs) entities among the set of allowed entiti(es) may generate a CSI payload size that is highest CSI payload size as compared to the CSI payload size generated by the remaining entity(es). Such a CSI payload may be termed as the maximum CSI payload. For example, a BS may allow rank values 1, 2, and 4. The rank value 4 generate a higher CSI payload as compared to the CSI payload generated by the rank value 1 and the rank value 2. The maximum CSI payload is the payload size generated by the rank value 4.

Actual UCI and/or CSI payload: Throughout this disclosure, the term actual UCI or CSI payload may refer to the UCI or CSI payload generated by the determined or selected entity (e.g., a rank value) or entities (e.g., rank value, layer index(es), TRPs, and/or channel state information-reference signal indicators (CRIs), etc.).

Redundant resources: Throughout this disclosure, the term redundant resources may refer to the resources that are being used for bit-padding by the WTRU. For example, the allowed rank values may be 1, 2, and 4. The rank value 4 generates the maximum payload size, e.g., the maximum payload size is 20 bits. The BS may assign uplink resources that can fit 20 bits. The WTRU may determine a rank value, e.g., the rank value is 2. The actual UCI and/or CSI payload based on the rank value 2, for example, is 15. The number of bits used for bit-padding is 20−15=5. The resources being used for transmission of the bit-padding bits is termed or known as redundant resources. An example of redundant resources is provided in FIG. 2.

Redundant bits: Throughout this disclosure, the term redundant bits may refer to the number of bit-padding bits or the number of bits transmitted using the redundant resources.

Condition-A: Throughout this disclosure, the terms, “condition-A is satisfied” and “condition-A is not satisfied” may refer to the following cases, scenarios, and/or conditions. Condition-A is not satisfied may refer to the situation when the actual CSI payload is equal to the maximum CSI payload, such a case or situation may be termed as condition-A is not satisfied. Condition-A is satisfied may refer to the situation when the actual CSI payload is not equal to the maximum CSI payload, e.g., when the actual CSI payload is less than the maximum CSI payload size, such a case or situation may be termed as condition-A is satisfied.

The existing method of bit-padding the redundant resources or transmitting bit-padding bits using the redundant resources is not efficient in terms of resources utilization. Described herein are mechanisms for a WTRU to efficiently utilize the redundant resources. Described herein are mechanisms for a WTRU to report CSI without using the redundant resources. Methods and procedures are described herein to dynamically change the reference signal (RS) (e.g., demodulated reference signal (DMRS)) configuration, code-rate, modulation and coding scheme (MCS), repeat the CSI, and/or CSI quantization parameter based on one or more association rules that includes, the number of redundant resources, if condition-A is satisfied or not, etc. Described herein is a two-step CSI reporting method and related procedure to enable the BS (e.g., gNB) to use the redundant resources or to enable the WTRU to use a smaller number of resources for transmission of the actual CSI payload.

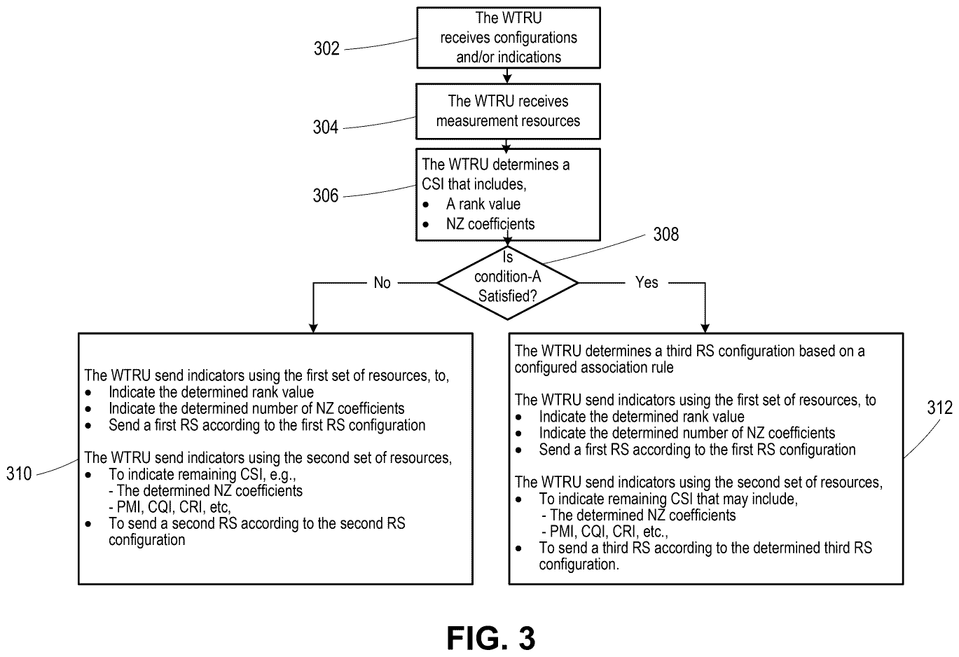

FIG. 3 is a an example flowchart depicting WTRU behavior of channel state information (CSI) determination and reporting. A WTRU may receive configuration information that include(s) indication(s) for one or more of the following at step 302. The WTRU may receive configuration information comprising an indication of measurement resource(s), e.g., channel state information reference signal (CSI-RS) resource(s), at step 302. The WTRU may receive a configuration information comprising an indication of report quantitie(s), e.g., a rank indicator (RI), and/or non-zero coefficient(s), at step 302. The WTRU may receive configuration information comprising an indication of a set of allowed rank value(s) and/or allowed layer index(es) at step 302. The WTRU may receive configuration information comprising an indication of a first number of non-zero coefficient(s) at step 302. The WTRU may receive configuration information comprising an indication of a first code-rate, a first Modulation and coding scheme (MCS), and/or a first set of quantization rule and/or quantization parameter(s) for CSI quantization at step 302. The WTRU may receive configuration information comprising an indication of a first reference signal(s) (RS) (e.g., DMRS) configuration and/or a second RS (e.g., DMRS) configuration at step 302. The WTRU may receive configuration information comprising an indication of one or more association rules at step 302. The one or more association rules may comprise an indication of how to determine a third RS (e.g., DMRS) configuration. The one or more association rules may comprise an indication of how to determine a third RS may comprise, for example, a number of symbols, time and/or frequency locations of the symbols, DMRS type, etc. The one or more association rules may comprise an indication regarding how to determine a set of quantization parameter(s) to quantize the determined CSI. The one or more association rules may comprise an indication of the number of bits to quantize one or more non-zero (NZ) coefficients and the step size between two quantized NZ coefficients. The one or more association rules may comprise an indication regarding how to determine a code rate (e.g., the ratio between the number of useful data bits and the total number of transmitted bits) and/or MCS, such as, for example, the modulation, error correction coding, etc.

The WTRU may receive configuration information comprising an indication of an uplink (e.g., PUCCH and/or PUSCH) resources, at step 302. The indication of uplink resources may comprise a first set of uplink resource(s). The first set of uplink resources may comprise an index(es) of first time-unit(s), e.g., index of a first symbol in a first slot. The first set of uplink resources may comprise an index(es) of one or more frequency-unit(s) (e.g., subcarrier(s)) at the first time-unit(s). The indication of uplink resources may comprise a second set of uplink resource(s). The second set of uplink resources may comprise an index(es) of second time-unit(s), e.g., second and third symbols in a second slot. The second set of uplink resources may comprise an index(es) of one or more frequency-unit(s) at the second time-unit(s).

The WTRU may receive configuration information comprising an indication of the measurement resource(s) to configure the WTRU perform one or more of the following at step 304. The indication of the measurement resources may configure the WTRU to determine a rank value from the set of allowed rank value(s). The indication of the measurement resources may configure the WTRU to determine a second number of non-zero (NZ) coefficient(s), where the second number of NZ coefficients is equal to or less than the first number of NZ coefficients.

The WTRU may receive configuration information to configure the WTRU to determine a first CSI payload size and a second CSI payload size at step 306. The first CSI payload size may be generated by the determined rank value (e.g., Rank1) and/or the CSI payload generated by the second number of NZ coefficients. The second CSI payload size may be the maximum CSI payload generated by a rank value (e.g., Rank2) in the allowed set of rank values and/or the CSI payload generated by the first number of NZ coefficients.

At step 308, the WTRU may determine if a condition (e.g., condition-A) is met. That is, the WTRU may determine if the first CSI payload is less than the second CSI payload at step 308. If it is determined that this condition is satisfied (at step 308), the WTRU may perform one or more of the following as indicates at step 312.

At step 312, the WTRU may determine a third RS configuration based on the configured association rule(s), for example, DMRS, the number of DMRS symbols and the locations. The WTRU may determines a second code-rate based on the configured association rule(s). The WTRU may determine a second set of CSI quantization parameters based on the configured association rule(s). The WTRU may use the first set of resources for one or more of the following. The WTRU may send an indicator to indicate the determined rank value (e.g., Rank1). The WTRU may send an indicator to indicate the second number of NZ coefficients. The WTRU may send a first RS based on the first RS configuration. The WTRU may send indicator(s) to indicate the remaining CSI with a second code-rate, a second MCS, and/or a second set of CSI quantization parameter(s) that are determined using one or more of the configured association rule(s). The WTRU may send a third RS(s) based on the determined third RS configuration.

If it is determined that the condition is not satisfied (at step 308), the WTRU may use the second set of resources for at least one of the following at step 310. The WTRU may send indicator(s) to indicate the remaining CSI(s) using the first code-rate, the first MCS, and/or quantized using the first set of quantization parameter(s), e.g., the actual NZ coefficients associated with the second number of NZ coefficients and/or other report quantite(s) (if configured). The WTRU may send a second RS(s) based on the second RS configuration.

When condition-A is satisfied, the WTRU may perform uplink transmissions with uplink transmission parameters determined based on one or more association rules that involves, the determined CSI and the redundant resources. When condition-A is satisfied, the WTRU may perform a two-step CSI reporting, wherein a first part of the CSI report that indicates the payload size of the second part of the CSI report, is sent to the BS in a first step and the second part of the CSI is sent to the BS in a second step. AS such, uplink resources may be efficiently utilized by the WTRU for uplink transmissions.

Throughout this disclosure, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’. Throughout this disclosure, a TRP (e.g., transmission and reception point) may be interchangeably used with one or more of TP (transmission point), RP (reception point), RRH (radio remote head), DA (distributed antenna), a network node, a sector (of a network node), and a cell (e.g., a geographical cell area served by a BS), but still consistent with this invention. Hereafter, Multi-TRP may be interchangeably used with one or more of MTRP, M-TRP, and multiple TRPs, but still consistent with this invention.

A WTRU may report a subset of channel state information (CSI) components, where CSI components may correspond to at least a CSI-RS resource indicator (CRI), a SSB resource indicator (SSBRI), an indication of a panel used for reception at the UE (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or non-zero quantized coefficient, e.g., amplitude scaling coefficients and/or phase coefficients.

Throughout this disclosure, a signal may be interchangeably used with one or more of following: sounding reference signal (SRS), channel state information—reference signal (CSI-RS), demodulation reference signal (DM-RS), phase tracking reference signal (PT-RS), synchronization signal block (SSB), consistent with this invention.

Throughout this disclosure, a channel may be interchangeably used with one or more of following: physical downlink control channel (PDCCH), physical downlink shared channel (PDSCH), physical uplink control channel (PUCCH), physical uplink shared channel (PUSCH), physical random access channel (PRACH), or the like, consistent with this invention.

Throughout this disclosure, a quantity, report quantity, uplink control information (UCI) and/or channel state information (CSI) may be interchangeably used with one or more of following: rank indicator (RI), Precoding matrix indicator (PMI), Channel quality indicator (CQI), Wideband channel quality indicator (W-CQI), Sub-band channel quality indicator (S-CQI), Wideband precoding matrix indicator (PMI), Layer indicator (LI), CSI reference resource index (CRI), Signal to noise and interference ratio (SINR), Reference signal received power (RSRP), Scheduling request, of the like, consistent with this invention.

Throughout this disclosure, downlink transmission or downlink reception may be used interchangeably with receive (Rx) occasion, PDCCH, PDSCH, SSB reception, consistent with this invention. Throughout this disclosure, uplink transmission or uplink reception may be used interchangeably with Tx occasion, PUCCH, PUSCH, PRACH, SRS transmission, consistent with this invention. Throughout this disclosure, RS may be interchangeably used with one or more of RS resource, RS resource set, RS port and RS port group, consistent with this invention. Throughout this disclosure, RS may be interchangeably used with one or more of SSB, CSI-RS, SRS and DM-RS, consistent with this invention.

Throughout this disclosure, time instance or time-unit may be interchangeably used with slot, symbol, subframe, frame, etc., consistent with this invention. Throughout this disclosure, frequency instance or frequency unit may be interchangeably used with subcarrier, resource element (RE), resource block, sub-band, band, bandwidth part, consistent with this invention. Throughout this disclosure, sub-set of antenna unit(s), and/or subset of pilot symbol(s) may be interchangeably used with CSI-RS resource(s). Throughout this disclosure, the term, “antenna unit” may refer to a physical antenna element or a logical antenna port etc. Throughout this disclosure, the terms, “power” and “amplitude” may be interchangeably used.

Throughout this disclosure, the mechanisms are discussed, proposed, and/or applied for the case or in the context when a CSI is determined based on one or more CSI-RS resources in a CSI-RS resource set. The mechanisms proposed here are equally, equivalently or extendedly applicable to the case when CSI is determined based on CSI-RS resources that belongs to or are associated to different CSI-RS resource set(s).

Throughout this disclosure, mechanisms are discussed, proposed, and/or applied for the case when there is no scheduling request transmission by the WTRU on the uplink channel and when there is no data transmission by the WTRU on the uplink channel. The methods or methods proposed in this disclosure are equally, similarly, or extendedly applicable to the cases when the uplink transmission includes indications for scheduling request and/or data.

Throughout this disclosure, the term, “entity” or “entities” may refer to one or more of the following, a transmitting receiving point (TRP), antenna ports, antenna elements, antenna panels, a hybrid beam, a digital beam, an RS, rank values, layer indexes, TRP indexes, panel indexes, SRS antenna ports, sub-band indexes, etc.

Throughout this disclosure, a CSI payload size or payload size may refer to the number of binary bits that may be used to represent the determined CSIs or the number of binary bits, e.g., without the error correction bits, that needs to be transmitted to report the CSI. Throughout this disclosure, the term CSI report may refer to one or more indications sent using the uplink resources. The indications may be partitioned into one or more parts. For example, a two parts CSI reports. CSI part 1 may refer to the first part of a CSI report. CSI part 2 may refer to the second part of a CSI report. CSI part 1 may include indications that indicates the payload size carried by CSI part 2. For example, CSI-part 1 may include indications for the rank value (RI) and the number of NZ coefficients. For example, CSI-part 2 may include indications for precoders (e.g., PMI), NZ coefficients and other parameters, e.g., CQI, wideband CQI, sub-band CQI etc.

Throughout this disclosure, the term modulation and coding scheme (MCS) and modulation order may be interchangeably used but still consistent with this invention. Throughout this disclosure, the term other parameters or report quantity may refer to one or more of the following, wideband PMI, Sub-band PMI, wideband CQI, sub-band CQI, differential sub-band CQI, LI, RI, CSI-RS resource index (CRI), first number of non-zero coefficient, where a non-zero coefficient may be an amplitude scaling factor or a phase coefficient for sub-band(s) and/or wideband. The number of CSI-RS antenna ports, discrete Fourier transform (DFT)-oversampling value, codebook modes, e.g., mode-1 or mode-2, codebook type, e.g., Type-I codebook, Type-II codebook, enhanced Type-II codebook, number of panels, e.g., single panel or multi-panel, Number of codewords, e.g., 1 codeword per panel, number of TRPs, and/or number of sub-bands, etc.

Throughout this disclosure, enhanced utilization of uplink resource or resources may refer to the use of methods and procedures proposed in this disclosure that can utilize the available resource more efficiently.

A WTRU may receive configuration information comprising one or more configurations to support efficient utilization of uplink resources. Examples may include configurations to support one or more of: measurement resources and report quantities, measurement restrictions, reporting parameters, reference signals, and/or association rules.

Mechanisms for the efficient utilization of uplink resources may (e.g., additionally) be initiated if supported by both the WTRU and the network (NW). A WTRU may indicate capability for one or more aspects of enhanced utilization of uplink resources e.g., prior to initiation of the procedure or reception of associated configurations. A NW may indicate support (e.g., per cell) for one or more aspects of enhanced utilization of uplink resources. A WTRU may, for example, initiate a procedure and/or expect configuration with a cell(s) which support the procedure. Mechanisms described herein support indication of WTRU capability, NW support, and the reception of one or more configurations to support the efficient utilization of uplink resources.

A capability may be needed to support the enhanced utilization of uplink resources. The capability may be related to all aspects of enhanced utilization of uplink resources, or one or more aspects. Support for enhanced utilization of uplink resources may be reported by the WTRU and/or indicated by the network (e.g., on a cell-specific basis).

A WTRU may indicate its capability and/or support for one or more aspects of enhanced utilization of uplink resources. The WTRU may indicate a single capability to indicate support for all aspects enhanced utilization of uplink resources. The WTRU may report support for an/each aspect enhanced utilization of uplink resources. For example, the WTRU may indicate support for one or more of the following: a number of TRPs, panels, antenna ports, and/or entities etc., one or more rows of Table 1, Table 2, or the like.

A WTRU may report the capability of one or more of the above aspects of enhanced utilization of uplink resources, for example, via the WTRU capability transfer procedure. The WTRU may indicate capability and/or support via one or more of the following methods. The WTRU may indicate capability and/or support via random access (or use of one or more dedicated resources, use of random access preamble partitioning e.g. a set of reserved preambles or random access occasions, radio network temporary identifiers (RNTIs), etc. The WTRU may indicate capability and/or support upon RRC connection establishment/resumption e.g. Msg3 or Msg5. The WTRU may indicate capability and/or support upon request from the network (e.g., upon reception of the capability enquiry message). The WTRU may indicate capability and/or support via WTRU assistance information.

The capability to support/perform/execute/initiate one or more aspects of enhanced utilization of uplink resources may be reliant/linked to one or more other configurations (e.g., RSs). If a WTRU is configured for enhanced utilization of uplink resources and an associated configuration is not present and/or active and/or the WTRU characteristics are not suitable, it may be assumed that the procedure is temporarily disabled (e.g., the WTRU may not initiate the procedure) or inactive. The WTRU may indicate (e.g., subject to configuration) to the network enhanced utilization of uplink resources is temporarily inactive e.g., via a MAC CE, UCI or RRC signalling. In some solutions, the WTRU may also report the reason for why the procedure is inactive (e.g., a joint configuration is disabled, or the WTRU characteristics are not suitable).

The network may indicate support for enhanced utilization of uplink resources. Support for enhanced utilization of uplink resources may be, for example, per cell, per public land mobile network (PLMN), per frequency, per tracking area (TA) or RAN notification area (RNA). The indication may be, for example, a flag and/or bit in system information which indicates support for enhanced utilization of uplink resources. In another example, the NW may indicate support for an aspect of the procedure (e.g., that the cell CSI determination but not reporting). In another solution, the network may indicate (e.g., within system information and/or via RRC configuration) a list of one or more cell(s) which support enhanced utilization of uplink resources. The WTRU may only initiate enhanced utilization of uplink resources or one or more aspects of enhanced utilization of uplink resources subject to the network supporting the procedure.

The WTRU may semi-statically or dynamically (e.g., by RRC, MAC-CE, and/or DCI) receive one or more implicit or explicit configurations and/or indications that indicates one or more of the following. The WTRU may semi-statically or dynamically receive one or more implicit or explicit configurations and/or indications that indicate measurement resources RS, e.g., CSI-RS, DMRS, etc. One or more CSI-RS resources may be RRC configured. The WTRU may receive DCI that includes a CSI request field that indicates one or more of the RRC configured CSI-RS resources. For two RRC configured CSI-RS resources, the DCI may indicate to determine a CSI based on the first CSI-RS resource.

The WTRU may semi-statically or dynamically receive one or more implicit or explicit configurations and/or indications that indicate report quantitie(s), for example, to report one or more of, wideband PMI, Sub-band PMI, wideband CQI, sub-band CQI, differential sub-band CQI, LI, RI, and/or CSI-RS resource index (CRI), first number of non-zero coefficient, where a non-zero coefficient may be an amplitude scaling factor or a phase coefficient for sub-band(s) and/or wideband.

The WTRU may semi-statically or dynamically receive one or more implicit or explicit configurations and/or indications that indicate codebook configuration, such as, for example, the number of CSI-RS antenna ports, DFT-oversampling value, codebook modes, e.g., mode-1 or mode-2, codebook type, e.g., Type-I codebook, Type-II codebook, enhanced Type-II codebook, number of panels, e.g., single panel or multi-panel, Number of codewords, e.g., 1 codeword per panel, number of TRPs, and/or number of sub-bands, etc.

The WTRU may semi-statically or dynamically (e.g., by RRC, MAC-CE, and/or DCI) receive one or more implicit or explicit configurations and/or indications that indicates one or more allowed entities. For example, a set of allowed rank values, where an allowed rank value in the set of allowed rank values may mean that the WTRU is allowed to select or determine a PMI value that has an associated rank indicator (RI) value or rank value that is present in the allowed set.

The WTRU may receive an RRC configured bitmap, e.g., RI-restriction, i.e., [1 0 1 1 0 0 0 0], that may mean that the WTRU is allowed to select a precoder, e.g., from a codebook of precoders that has an associated rank value equal to RI=1, 2, or 3. Alternatively, the bit-map may mean that the UE is allowed to select a precoder, e.g., from a codebook of precoders that has an associated rank value equal to RI=1, 2, 3, 4, 5.

The WTRU may receive an RRC configured bitmap, e.g., RI-restriction, i.e., [1 0 1 1 0 0 0 0], that may mean that the UE is allowed to select a precoders for layers 1, 3 and 4, e.g., from a codebook of precoders. Alternatively, the bit-map may mean that the WTRU is allowed to select precoders for layers 2, 5, 6, 7, and/or 8.

The WTRU may semi-statically or dynamically receive one or more implicit or explicit configurations and/or indications that indicate a set of allowed TRPs, where an allowed TRP in the set of allowed TRPs may mean that the UE is allowed to select or determine a CSI for the TRP. For example, the WTRU may receive an RRC configured bitmap, e.g., TRP-restriction, i.e., [1 0 1 1 0 0 0 0], that may mean that the UE is allowed to select or determine a CSI for a TRP in the set of allowed TRPs. Alternatively, the bit-map may mean that the WTRU is allowed to select or determine a CSI for TRP that is not present or indicated by the set of TRPs.

The WTRU may semi-statically or dynamically (e.g., by RRC, MAC-CE, and/or DCI) receive one or more implicit or explicit configurations and/or indications that indicates the following.

The WTRU may semi-statically or dynamically receive one or more implicit or explicit configurations and/or indications that indicate a first number of non-zero coefficients, e.g., the first number of non-zero (NZ) coefficients is 20. The NZ coefficients may be amplitude scaling coefficients or phase coefficients, e.g., 20 amplitude scaling coefficients and/or 20 phase coefficients. The coefficient may be for one or more time-unit(s) and/or frequency-unit(s) at one or more CSI-RS antenna port(s).

The WTRU may semi-statically or dynamically (e.g., by RRC, MAC-CE, and/or DCI) receive one or more implicit or explicit configurations and/or indications that indicates one or more of the following.

The WTRU may semi-statically or dynamically receive one or more implicit or explicit configurations and/or indications that indicate an implicit or explicit indication to report the determined CSI in a single instance of CSI transmission or in two different CSI instances of CSI transmission, e.g., CSI part 1 and CSI part 2. For example, a Type-I CSI or a CSI being transmitted on PUCCH format-2 may be a single part CSI transmission. A Type-I CSI or a transmitted on PUCCH format-3 may be a two part CSI transmission.

The WTRU may semi-statically or dynamically receive one or more implicit or explicit configurations and/or indications that indicate a first code-rate, e.g., error correction scheme, number of useful bits and error correction bits, for a single part CSI, for a CSI part 1 of a CSI report and for CSI part 2 of a CSI report. For example, a single part CSI report may have a code-rate equal to ½. Part 1 of a CSI report may have a first code-rate equal to ⅓ and part 2 of a CSI report may have a code-rate equal to ½.

The WTRU may semi-statically or dynamically receive one or more implicit or explicit configurations and/or indications that indicate a first modulation and coding scheme (MCS) for a CSI report, a first MCS for CSI part 1 and a first MCS for CSI part 2. The MCS may be based on binary phase shift keying (BPSK) modulation for the CSI report. The MCS may be based on binary phase shift keying (BPSK) modulation for CSI part 1. The MCS may be based on quadrature phase shift keying (BPSK) modulation for CSI part 2.

The WTRU may semi-statically or dynamically (e.g., by RRC, MAC-CE, and/or DCI) receive one or more implicit or explicit configurations and/or indications that indicates one or more of the following.

The WTRU may semi-statically or dynamically receive one or more implicit or explicit configurations and/or indications that indicate a first rule that may be used to quantize the non-quantized NZ coefficients.

The WTRU may semi-statically or dynamically receive one or more implicit or explicit configurations and/or indications that indicate a first set of parameter values or variable values that may be used in a first rule that is used for quantizing the non-quantized coefficients.

The WTRU may semi-statically or dynamically receive one or more implicit or explicit configurations and/or indications that indicate a second rule that may be used to quantize the non-quantized NZ coefficients.

The WTRU may semi-statically or dynamically receive one or more implicit or explicit configurations and/or indications that indicate a second set of parameter values or variable values that may be used in a first rule or a second rule that is used for quantizing the non-quantized coefficients.

The WTRU may semi-statically or dynamically (e.g., by RRC, MAC-CE, and/or DCI) receive one or more implicit or explicit configurations and/or indications that indicates one or more of the following.

The WTRU may semi-statically or dynamically receive one or more implicit or explicit configurations and/or indications that indicate a first RS configuration, such as, for example, a first DMRS configuration that includes indications for the number of symbols, location of symbols, and DMRS type. The first DMRS configuration may be for CSI part 1, e.g., the time and/or frequency locations of the first DMRS configuration or RS is close in time and/or frequency to the time and/or frequency resources for reporting of CSI part 1. The locations of the first DMRS may be at symbol 1 and subcarriers 1, 3, 5, 7, 9, etc. in a slot.

The WTRU may semi-statically or dynamically receive one or more implicit or explicit configurations and/or indications that indicate a second RS configuration, such as, for example, a second DMRS configuration that includes indications for the number of symbols, location of symbols, and DMRS type. The second DMRS configuration may be for CSI part 2, i.e., the time and/or frequency locations of the second DMRS configuration or RS is close in time and/or frequency to the time and/or frequency resources for reporting of CSI part 2. The locations of the second DMRS may be at symbol 3 and symbol 5 and subcarriers 1, 4, 6, 8, etc., in a slot.

The WTRU may semi-statically or dynamically receive one or more implicit or explicit configurations and/or indications that indicate a common RS configuration, such as, for example, a single RS configuration, where the single RS configuration may have M₁ and M₂ number of DMRS symbols. The M₁ and M₂ DMRS symbols has fixed, configured, or indicated time and/or frequency locations. The first RS, second RS, and common RS may be transmitted by the WTRU on the configured uplink, e.g., PUCCH or PUSCH channel with the determined CSI. The first RS, second RS, and the third RS may be meant for channel estimation to demodulate the CSI.

Association rules may facilitate a determination of a third RS (e.g., DMRS) configuration, a number of symbols, time and/or frequency locations of the symbols, DMRS type, etc., a determination of a set of quantization parameter(s) to quantize the determined CSI, the number of bits to quantize one or more NZ coefficients and the step size between two quantized NZ coefficients, a determination of a code rate and/or MCS, modulation, error correction coding, etc., of the like, or any appropriated combination thereof.

The WTRU may semi-statically or dynamically (e.g., by RRC, MAC-CE, and/or DCI) receive one or more implicit or explicit configurations and/or indications that indicates one or more of the following.

The WTRU may semi-statically or dynamically receive one or more implicit or explicit configurations and/or indications that indicate a first association rule, where the first association rule may be used by the WTRU to determine a third RS configuration.

The WTRU may semi-statically or dynamically receive one or more implicit or explicit configurations and/or indications that indicate a second association rule, where the second association rule may be used by the WTRU to determine a second quantization rule or a second set of parameter values for the first quantization rule.

The WTRU may semi-statically or dynamically receive one or more implicit or explicit configurations and/or indications that indicate a third association rule, where the third association rule may be used by the WTRU to determine a second code-rate and/or a second MCS.

The WTRU may receive an single association rule, e.g., a common association rule to determine a third RS, a second association rule, a second set of parameter values for a first association rule, a second code-rate, a second MCS, number of bits for bit-padding, etc. The first association rule, the second association rule, and the third association rule may be used by the WTRU to determine when condition-A is satisfied to determine a third RS configuration, a second quantization rule and/or second set of parameter values of a quantization rule, a second code-rate for CSI part 1 and/or a second code-rate for CSI part 2, or a second code-rate for the CSI report, and/or a second MCS for CSI part 1 and/or a second MCS for CSI part 2, or a second MCS for the CSI report.

Methods to (re)acquire, adapt, or release configurations for enhanced utilization of uplink resources may be utilized to ensure that a WTRU may continue to maintain related configurations and enhancements.

Signaling of enhanced utilization of uplink resources configuration(s) may be applicable. A WTRU may be provided with configurations for enhanced utilization of uplink resources upon establishment/resumption of an RRC connection (e.g., within the RRC Setup/Resume message) or upon handover to another cell (e.g., within a handover (HO) command/RRC reconfiguration message with a reconfiguration with sync) or at any time during an active RRC connection (e.g., RRC reconfiguration message without reconfiguration with sync). Configurations of enhanced utilization of uplink resources may be indicated/configured/provided via one or more of the following signaling methods: system information block (SIB) (e.g., a new system information (SI) block, or within another existing SIB), non-access stratum (NAS), MAC CE, DCI, RACH (e.g., MSG2, MSG4, MSGB), RRC, and/or PDCCH/PUSCH.

The WTRU may receive different information and/or components of a configuration for enhanced utilization of uplink resources via different signaling methods. The WTRU may receive some dedicated configuration aspects via RRC signalling (e.g., measurement restrictions, reporting parameters etc.), and some other configurations or information via system information (e.g., and indication that an enhanced utilization of uplink resources operation is supported in the cell). If a WTRU is provided with a dedicated configuration/indication related to enhanced utilization of uplink resources, the WTRU may override other common configuration information (e.g., received via broadcast signalling) or may combine the dedicated configuration with one or more pieces of common configuration information. In another example, the WTRU may use the most recently received information in the configuration regardless of the signalling method.

The WTRU may receive one or more alternative configurations using one signalling method (e.g. via system information or dedicated RRC signalling). Using another type of signalling (e.g. via dedicated RRC signalling or MAC CE) the network may select or indication which of the one or more alternative configurations to apply.

Configuration(s) for enhanced utilization of uplink resources may be handled in any appropriate manner. A WTRU may receive a configuration based on NW decision (e.g., upon release to RRC IDLE or RRC INACTIVE) for example, if the WTRU indicates it is capable of enhanced utilization of uplink resources.

The WTRU may request to be configured for enhanced utilization of uplink resources. The WTRU may request configuration(s) for enhanced utilization of uplink resources, update existing configuration(s) enhanced utilization of uplink resources, and/or apply different configuration(s) for enhanced utilization of uplink resources based on one or more of the following. The WTRU may request to be configured for enhanced utilization of uplink resources when the actual rank value or RI is better than the maximum rank value that is restricted by the network node. For example, the network node may allow rank values 1, 2, and 3. However, the actual rank value is better than the rank value 3, i.e., the actual rank value is 8.

The WTRU may determine that using a number of NZ coefficients larger than the first number of NZ coefficients is more useful than the first number of coefficients. For example, if the first number of coefficients is 10, the WTRU may determine that 20 coefficients can significantly enhance the throughput performance. The WTRU thus may request new configurations for CSI determination that will allow it to determine a larger number of NZ coefficients.

The WTRU may release related configurations for enhanced utilization of uplink resources (e.g., all or one or more parts of a configuration), for example, upon one or more of the following circumstances. The WTRU may release related configurations for enhanced utilization of uplink resources when the current serving cell does not support enhanced utilization of uplink resources. The WTRU may release related configurations for enhanced utilization of uplink resources when the maximum restricted rank value is more than the rank value determined by the WTRU. For example, the network node (e.g., base station, gNB, eNB) may allow the WTRU to select rank value 1, 2, and 3. The WTRU may determine a rank value equal to 1. However, the resources are being assigned by the network node assuming a rank value equal to 3. The WTRU therefore may release the configurations.

Resources assignment for CSI reporting may include uplink (e.g., PUCCH and/or PUSCH) resources, e.g., a first set of uplink resources and/or a second set of uplink resources. First set of uplink resources may include index(es) of first time-unit(s), e.g., index of a first symbol in a first slot and/or index(es) of one or more frequency-unit(s) (e.g., subcarrier(s)) at the first time-unit(s). Second set of uplink resource(s) may include index(es) of second time-unit(s), e.g., second and third symbols in a second slot and/or index(es) of one or more frequency-unit(s) at the second time-unit(s).

The WTRU may semi-statically or dynamically (e.g., by RRC, MAC-CE, and/or DCI) receive one or more implicit or explicit configurations and/or indications that indicates one or more of the following. The WTRU may semi-statically or dynamically receive one or more implicit or explicit configurations and/or indications that indicate a first set of resources for CSI reporting, e.g., for reporting CSI part 1. The WTRU may receive a DCI that includes indications for time-domain resources allocation (TDRA), e.g., a bitmap indicating one or more localized or interleaved time-units, a starting time-unit and a number of time-units, and/or a configured time grant. The WTRU may receive a DCI that includes indications for frequency-domain resources allocation (FDRA), e.g., a bitmap indicating one or more localized or interleaved frequency-units, a starting frequency-unit and a number of frequency-units, and/or a configured frequency grant. The first 12 resource elements (Res) at the first symbol in a slot may be used for reporting the CSI contents of CSI part 1. The even-numbered REs at the first symbol in a slot may be used for reporting the CSI contents of CSI part 1. The odd-numbered REs at the first symbol in a slot may be used for sending first RS, e.g., DMRS.

The WTRU may semi-statically or dynamically receive one or more implicit or explicit configurations and/or indications that indicate a second set of resources for CSI reporting, e.g., for reporting CSI part 2. The WTRU may receive a DCI that includes indications for time-domain resources allocation (TDRA), e.g., a bitmap indicating one or more localized or interleaved time-units, a starting time-unit and a number of time-units, and/or a configured time grant. The WTRU may receive a DCI that includes indications for frequency-domain resources allocation (FDRA), e.g., a bitmap indicating one or more localized or interleaved frequency-units, a starting frequency-unit and a number of frequency-units, and/or a configured frequency grant. The first 12 REs at symbols 11, 12, 13, and symbol 14 in a slot may be used for reporting the CSI contents of CSI part 2. The even-numbered REs at symbols 11, 12, 13, and symbol 14 in a slot may be used for sending second RS, e.g., DMRS.

The WTRU may semi-statically or dynamically receive one or more implicit or explicit configurations and/or indications that indicate a set of time and/or frequency domain resources for reporting a CSI with one or more semi-statically or dynamically indicated indications to indicate resources for CSI part 1, CSI part 2, positive acknowledgement (ACK)/negative acknowledgement (NACK), DMRS, etc. The WTRU may receive indications for a set of time and/or frequency resources. The additional indication may indicate a subset of resources within the set of resources for reporting the determined CSI, e.g., a first subset of resources for reporting CSI part 1 and a second subset of resources for reporting CSI part 2.

The WTRU may semi-statically or dynamically receive one or more implicit or explicit configurations and/or indications that indicate spatial domain resources for CSI reporting. For example, a first layer in a configured number of uplink layers may be used for reporting the CSI.

The WTRU may receive the measurement resource(s) and determine a rank value from the set of allowed rank value(s), determine a second number of non-zero (NZ) coefficient(s), where the second number of NZ coefficients is equal to or less than the first number of NZ coefficients, or any appropriate combination thereof.

The WTRU may receive a CSI-RS resource configuration to measure/determine CSI. The WTRU may be configured with a CSI-RS resource set and the WTRU may use the single CSI-RS resource set to determine the CSI contents from the set of allowed rank values (e.g., set [symbol] ) and the set of number of non-zero (NZ) coefficients values (e.g., [symbol] ). Different sub-configuration of the CSI-RS resource or resource set may be configured to determine different CSI contents. Each sub-configuration may configure different parameters from the same CSI-RS resource. The parameters may include one or more of the following: number of ports, power offset, polarization, wideband PMI, sub-band PMI, number of ports, DFT-oversampling, codebook modes, number of panels, CRI/non-CRI, number of codewords, wideband CQI, sub-band CQI, differential sub-band CQI, LI, RI, number of sub-bands, powerControlOffset and powerControlOffsetss values, modulation and code rate and analog beam e.g., transmission configuration indication (TCI), CSI-RS Resource Indicator (CRI) or SS Block Resource Indicator (SSBRI). Throughout this disclosure, we refer to these parameters as other parameters and there are provided some examples for some of these parameters. However, the overall discussion may encompass one or more of the other parameters.

For example, the WTRU may determine the rank from the set of allowed ranks and a number of coefficients, e.g., the second number of coefficients from the set of the number of NZ coefficients based on one or more of a number of CSI-RS ports, polarization, DFT oversampling, codebook mode, powerControlOffset and powerControlOffsetss values, or any appropriate combination thereof.

Number of CSI-RS ports: The WTRU may be configured with one or more threshold(s) for ports numbers (e.g., N1ₚₒᵣₜₛ, N2ₚₒᵣₜₛ, . . . ) to determine a rank value and NZ coefficients. If the WTRU is configured with N1ₚₒᵣₜₛ<N<N2ₚₒᵣₜₛ, ports, the WTRU may determine the rank value from one set of rank, e.g., [symbol] 1 where [symbol] 1∈ [symbol] and determine the NZ coefficients from one set of coefficients, e.g., [symbol] 1 where [symbol] 1∈ [symbol] . Otherwise, the WTRU may determine the rank value and NZ coefficients from the different set of rank, e.g., [symbol] 2 where [symbol] 2∈ [symbol] and determine NZ coefficients from different set of coefficients, e.g., [symbol] 2 where [symbol] 2∈ [symbol] .

Polarization: The WTRU may be configured with only one or two antenna polarization(s) for receiving the data stream. Based on this polarization, the WTRU may determine the rank value and NZ coefficients from the different set of rank values and NZ coefficient. If the WTRU is configured with two polarizations to receive the CSI-RS resource, the WTRU may determine the rank value from one set of rank, e.g., [symbol] 3 where [symbol] 3∈ [symbol] and determine NZ coefficients from one set of coefficients, e.g., [symbol] 3 where [symbol] 3∈ [symbol] . Otherwise, the WTRU may determine the rank value from another set of rank, e.g., [symbol] 4 where [symbol] 4∈ [symbol] and NZ coefficients from another set of coefficients, e.g., [symbol] 4 where [symbol] 4∈ [symbol] .

DFT-oversampling: The WTRU may be configured with a value and a threshold for DTF-oversampling, e.g.,

$${O}_{1} , {O}_{2} and {O}_{1}^{th} , {O}_{2}^{th} . If {O}_{1} < {O}_{1}^{th} and / or {O}_{2} < {O}_{2}^{th} .$$

The WTRU may determine the rank value from one set of rank, e.g., [symbol] 5 where [symbol] 5∈ [symbol] and determine NZ coefficients from one set of coefficients, e.g., [symbol] 5 where [symbol] 5∈ [symbol] . Otherwise, the WTRU may determine the rank value from another different set of rank, e.g., [symbol] 2 where [symbol] 2∈ [symbol] and determine NZ coefficients from one set of coefficients, e.g., [symbol] 2 where [symbol] 2∈ [symbol] .

Codebook mode: If the WTRU is configured with codebook type I, the WTRU may determine NZ coefficients from one set of NZ coefficients and if the WTRU is configured with codebook type II, the WTRU may determine another set of NZ coefficients. The WTRU may be able to determine the rank value from one set of rank values for both codebook type I and codebook type II. Codebook mode and number of DFT-oversampling together may allow the WTRU to determine the rank value and NZ coefficients from the different set of allowed rank and NZ coefficients.

powerControlOffset and powerControlOffsetss values: The rank value may be restricted based on powerControlOffset and powerControlOffsetss values for each CSI-RS resource. The WTRU may be configured with one or two thresholds for powerControlOffset and/or powerControlOffsetss value, i.e., PCOₜₕ and PCOSₜₕ. If powerControlOffset>PCOₜₕ and/or powerControlOffsetss>PCOSₜₕ, the WTRU may determine the rank value from a specific set of ranks.

The WTRU may first determine the rank value from the set of allowed ranks and then, based on the determined rank value, the WTRU may determine a number of NZ coefficients from the set of NZ coefficients. For example, if the rank value is 2, the WTRU may select a first number of NZ coefficients for the first layer from [symbol] 1 where [symbol] 1∈ [symbol] and select a second number of NZ coefficients for the second layer from [symbol] 2 where [symbol] 2∈ [symbol] .

The WTRU may be configured with a rank threshold(s), i.e., Rₜₕ(s). If the WTRU determines the rank value R where Rₜₕ<R, the WTRU may determine NZ coefficients from a set of NZ coefficients for rank(s) from 1 to Rₜₕ and then determine NZ coefficients from another set of NZ coefficients for rank(s) from Rₜₕ+1 to R.

To make sure that the selected NZ coefficients from different sets for different layers are orthogonal/semi-orthogonal, the WTRU may determine a co-phase coefficient among the layers. For example, if R=2 and Rₜₕ=1, the WTRU may determine a co-phase coefficient between layer 1 and layer 2. In another example, if R=3 and Rₜₕₛ=1, 2 the WTRU may determine NZ coefficients from 3 different sets of NZ coefficients. Then, the WTRU may determine two co-phase factors among the layers, i.e., one co-phase factor for layer 2 and another co-phase factor for layer 3.

In another example, if R=4 and Rₜₕ=1, 3 the WTRU may select NZ coefficients from one set of NZ coefficients for rank 1, from another set of NZ coefficients for ranks 2 and 3, from different set of NZ coefficients from the first and second sets for rank 4. Then, the WTRU may determine two co-phase factors including a co-phase coefficient between layer 1 and layer 2, 3 and another co-phase coefficient for layer 4.

If the WTRU is configured with a CSI-RS set including multiple CSI resources, the WTRU may determine the rank value from one set of allowed rank that is common among the multiple resources and may determine coefficients from different sets of NZ coefficients for each CSI-RS resource.

If the WTRU is configured with one CSI-RS set including two CSI-RS resources, the WTRU may determine the first PMI from one set of NZ coefficients and the second PMI from another set of NZ coefficients. To consider the orthogonality/semi-orthogonality between the two PMIs, the WTRU may determine a co-phase between the two PMIs is such a way that SINR is maximized. The WTRU may jointly determine the first PMI from one the first PMI from one set of NZ coefficients, the second PMI from another set of NZ coefficients, and the co-phase factor between two PMIs in such a way that SINR is maximized. In this case, the cost of WTRU computation is higher than previous case where the first and second PMIs separately selected from the sets to maximize the SINR.

If the WTRU is configured with multiple panels (e.g., N_{P} panels) to receive a CSI-RS set including multiple CSI resources, where each panel is corresponding to each CSI-RS resource, again the above-mentioned procedure may be followed. The WTRU may determine each PMI corresponding to each panel from the same/different set of NZ coefficients. Then, WTRU may determine N_{P}−1 co-phase factor among PMIs and concatenate all PMIs to select one PMI for the CSI-RS set over multi panels. The WTRU may jointly determine the PMIs and the co-phase factors among PMIs for the multi panel case. Then, the WTRU may determine/report one PMI by concatenating the PMIs or determine/report all NZ coefficients along with their co-phase factors.

The WTRU may determine NZ coefficients for each panel corresponding to each CSI-RS resources based on one or more of other parameters. For example, the WTRU may determine NZ coefficients for each panel corresponding to each CSI-RS resource based on powerControlOffset and powerControlOffsetss values. Since each CSI-RS resource may have different powerControlOffset and powerControlOffsetss value, the set of NZ coefficients may be determined for each panel could be different. Then, the WTRU may determine/report one PMI for each panel along with N_{P}−1 co-phase factor among PMIs. The WTRU may determine/report one PMI for all panels, where co-phase factors have been taken into consideration.

The WTRU may determine NZ coefficients based on wideband PMI or sub-band PMI for each panel, e.g., WTRU may determine the CSI contents the one set of allowed rank values and one set of non-zero (NZ) coefficients values. These two sets may be determined by wideband PMI or sub-band PMI. One panel of the WTRU may be configured with these two sets based on wideband PMI while the other panels may be configured sub-band PMI. The WTRU may be configured with a priority for the panels and determine NZ coefficients from a given set for each panel based on priorities. For example, a WTRU with two panels may be configured with panel priority. Then, the WTRU may determine NZ coefficients for the higher priority based on sub-band PMI which may determine NZ coefficients for the lower priority based on wideband PMI.

The set of NZ coefficients for each panel may be determined based on the number of sub-bands, e.g., if the WTRU is configured with number of sub-band greater than a threshold, the WTRU may determine NZ coefficients from one given set. Otherwise, the WTRU may determine NZ coefficients from another given set.

If the WTRU is configured with multiple TRPs (e.g., N_{P} TRPs), the WTRU may receive a CSI-RS resource from each TRP and determine the rank from the set of allowed ranks and coefficients from the set of NZ coefficients for each TRP. The set of allowed rank may be the same among all TRPs while the set of NZ coefficients may be different. The WTRU may determine the NZ coefficients from each NZ coefficient associated to each TRP. This determination can be done based on one or more of other parameters for each TRP. Then, the WTRU may determine/report N_{P} rank values and NZ coefficients for each CSI-RS resource.

When the WTRU is configured with multi TRPs, each set of NZ coefficients associated with each TRP may be different. The determined NZ coefficients from each set may have different number of bits for quantization and the different step size between two quantized NZ coefficients. In each set of NZ coefficients, the number of bits for quantization may be different for one or more coefficients.

Transmission parameters and DMRS configuration determination may be based on the configured association rules. The WTRU may determine a first CSI payload size and a second CSI payload size. Regarding the first CSI payload size, the CSI payload may be generated based on the determined rank value (e.g., Rank1) and/or the CSI payload generated by the second number of NZ coefficients. Regarding the second CSI payload size, the maximum CSI payload may be generated based on a rank value (e.g., Rank2) in the allowed set of rank values and/or the CSI payload generated by the first number of NZ coefficients.

The WTRU may determine if the condition (e.g., condition-A), e.g., the first CSI payload is less than the second CSI payload is satisfied and performs one or more of the following. If condition-A is satisfied, the WTRU may determine a third RS configuration based on the configured association rule(s). The third RS configuration may comprise the DMRS, the number of DMRS symbols, and the locations. If condition-A is satisfied, the WTRU may determine a second code-rate based on the configured association rule(s). If condition-A is satisfied, the WTRU may determine a second set of CSI quantization parameters based on the configured association rule(s).

The WTRU may determine a first CSI payload size and a second CSI payload size. Regarding the first CSI payload size, the CSI payload may be based on the determined rank value (e.g., Rank1), the CSI payload generated by the second number of NZ coefficients, and/or other parameters. The configured report quantities may be RI, precoder, and NZ coefficients. The RI-restriction bitmap is [1 1 0 1 0 0 0 0]. The allowed rank values are 1, 2, and 3. Reporting the rank value may be N_{RI}=┌log₂ 3┐=2 bits, where ┌ ┐ is the mathematical ceiling operation or function. Reporting a precoder for each layer may be 5 bits. The WTRU may determine a rank value or RI equal to RI=2. The WTRU may determine precoders for each layer, that generates 2*5=10 bits, where * is mathematical multiplication operation. The first number of NZ coefficients may be 15. Reporting each NZ coefficient may be 3 bits. The WTRU may determine 5 NZ coefficients that generates, 3*5=15 bits. The first CSI payload may equal N_{RI}+B(i)=2+10+15=27 bits. The actual CSI payload may be 27 bits.

Regarding the second CSI payload size, the maximum CSI payload generated by a rank value (e.g., Rank2) in the allowed set of rank values and/or the CSI payload may be based on the first number of NZ coefficients. For example, the RI-restriction bitmap may be [11 0 1 0 0 0 0]. The allowed rank values may be 1, 2, and 3. Reporting the rank value be N_{RI}=┌log₂ 3┐=2 bits. The first number of NZ coefficients may be 15. Reporting each NZ coefficient may be 3 bits. The number of bits needed to report the first number of coefficients may be 3*15=45. Reporting a precoder for each layer may be 5 bits. The number of bits needed to report precoders for layer 1, layer 2, and layer 4 may be 3*5=15. The first CSI payload may equal N_{RI}+B(i)=2+15+45=62 bits.

In legacy configurations, a WTRU assumes that the assigned uplink resources (based on the example) can fit 62 bits based on the first code-rate and the first MCS. Since the actual CSI payload or the first CSI payload is 27 bits, the WTRU adds 62-27=35 bits to the first CSI payload so that assigned resources are used for uplink transmission.

Each symbol of the first RS may be based on, for example N₁ a number of bits. The first RS with M₁ number of symbols is therefore based on M₁N₁ number of bits. Each symbol of the second RS may be based on, for example N₂ a number of bits. The second RS with M₂ number of symbols is therefore based on M₂N₂ number of bits.

The WTRU may assume one or more of the following. The WTRU may assume that the first set of the assigned uplink resources may fit the CSI payload generated by the indicator in CSI part 1. The WTRU may assume that the first set of the assigned uplink resources may fit the CSI payload generated by the indicator in CSI part 1 and the first RS, e.g., the M₁N₁ number of bits. Alternatively, the WTRU may assume that the first set of uplink resources may only be for the CSI part 1 and the first DMRS symbols may be punctured on first set of uplink resources, where the term punctured may refer to using one or more resources for RS, e.g., DMRS instead of CSI. The WTRU may assume that the second set of the assigned uplink resources may fit the maximum CSI payload generated by the allowed entities. The WTRU may assume that the second set of the assigned uplink resources may fit the second CSI payload generated by the allowed entities and the M₂N₂ number of bits. Alternatively, the WTRU may assume that the second set of uplink resources may only be for CSI part 2 and the second DMRS symbols may be punctured on second set of uplink resources. The WTRU may assume that the WTRU and the network node may have a common understanding of which resources among the common set of resources the UE may use for transmission of the CSI part 1, first RS, CSI part 2, etc. The WTRU may assume that the common set of resources may fit the second payload size, the first RS, and/or the second RS. For example, the assigned resources (e.g., the first set of resources, the second set of resources, and/or the common resources) are sufficient for reporting the 62 bits, the first RS and/or the second RS. Alternatively, the second set of uplink resources may only be for the second CSI payload and the second DMRS symbols may be punctured on second set of uplink resources, where the term punctured may refer to using one or more resources for RS, e.g., DMRS instead of CSI.

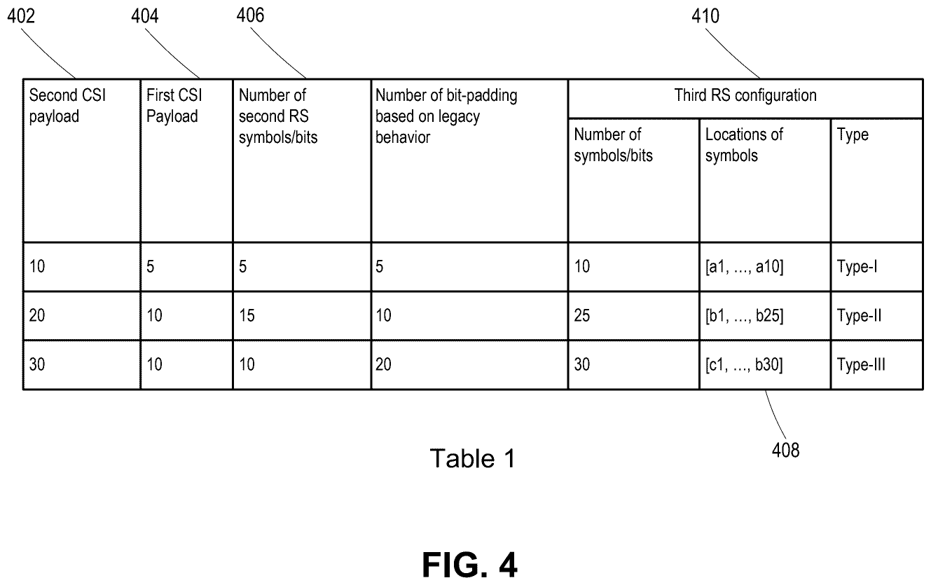

FIG. 4 is an example table (Table 1) of a first association rule for determining a third CSI configuration (410). In the example, it is assumed that the resources for the first RS and the second RS are separately assigned from the resources for CSI reporting. The example considers management of the resources for CSI part 2. The example considers management of resources in terms of the number of bits that can be transmitted using the resources.

As depicted in Table 1 of FIG. 4, the network node may assign resources to the WTRU that can fit a second CSI payload (402). The WTRU may determine a CSI, e.g., CSI part 2, that has a payload size in bits equal to the first CSI payload (404). The network node may configure a number of second RS symbols/bits (406) for transmission. Instead of bit-padding, the WTRU may use the redundant resources for sending an increased number of DMRS symbols.

For example, when second CSI payload is 10 bits and first CSI payload is 5 bits, the redundant resources that can fit 5 bits are used for sending DMRS symbols. The number of additional DMRS symbols based on the association rule will be 5. The number of total DMRS symbols based on the association rule is 10. The time and/or frequency positions of the 10 DMRS symbols (408) is determined using the association rule, e.g., denoted by [a1, . . . , a10], where each of a1, . . . a10 indicates a time and/or frequency location(s).

The time and/or frequency locations of the number of RS symbols configured by the second RS configuration may be the same as the locations configured by the second RS configuration. The time and/or frequency locations of the additional DMRS or RS symbols may be determined based on a configured, indicated or fixed association rule.

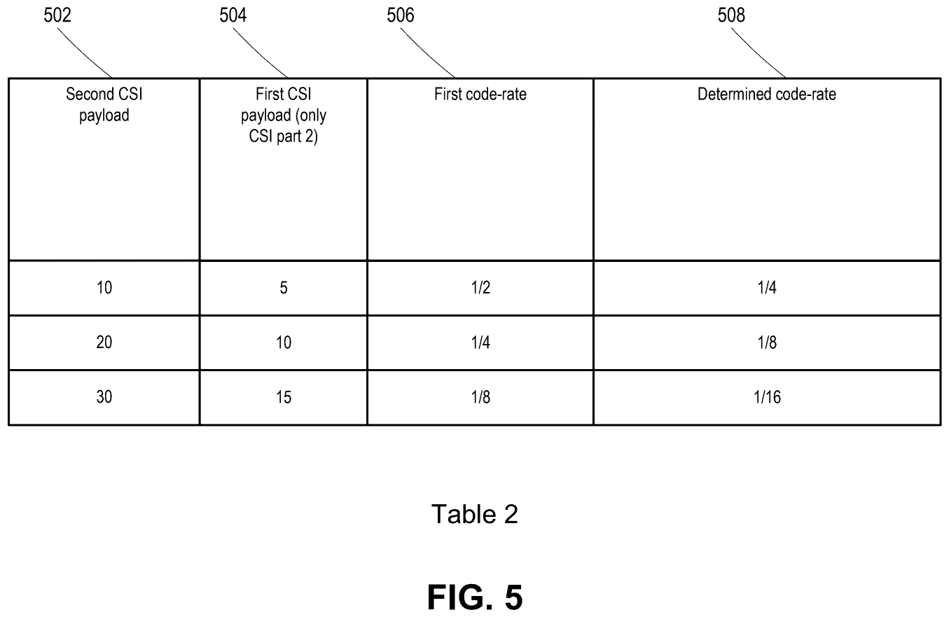

FIG. 5 is an example table (Table 2) of a second association rule for determining a second code rate (508). In the example, it is assumed that the resources for the first RS and the second RS are separately assigned than the resources for CSI reporting. The example considers management of the resources for CSI part 2. The example considers management of resources in terms of the number of bits that can be transmitted using the resources.

As depicted in Table 2 of FIG. 5, the network node may assign resources to the WTRU that can fit a second CSI payload (502) at a first code-rate (506). The WTRU may determine a CSI, e.g., CSI part 2, that has a payload size in bits equal to the first CSI payload (504). Instead of bit-padding, the WTRU may transmit CSI part 2 at a second code rate (508).

In an example, the WTRU may be configured to report CSI with resources that can fit 20 useful bits (e.g., without counting the error correction bits). The WTRU may determine a first CSI whose CSI part 2 has a payload size equal to first CSI payload. Instead of reporting the 5 first CSI payload bits at a code-rate of 1/2, the WTRU may report the first CSI payload bits at a code-rate of 1/4 to enhance the reliability.

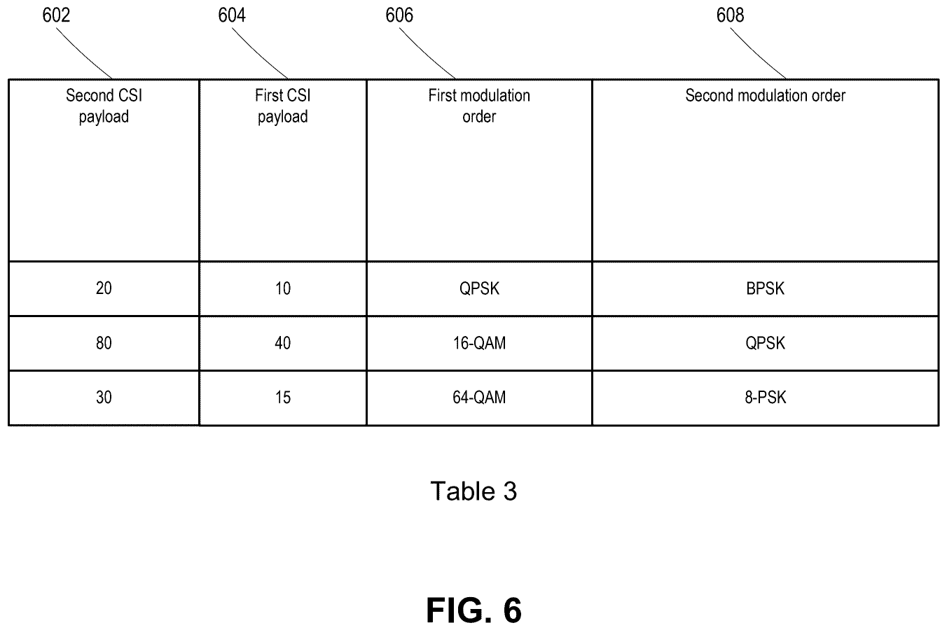

FIG. 6 is an example table (Table 3) of a third association rule for determining a MCS (608). The example considers management of the resources for CSI part 2. The example considers management of resources in terms of the number of bits that can be transmitted using the resources.

As depicted in Table 3 of FIG. 6, the network node may assign resources to the WTRU that can fit a second CSI payload (602) (in bits) at a first MCS (606). The WTRU may determine a CSI, e.g., CSI part 2, that has a payload size in bits equal to the first CSI payload (604). Instead of bit-padding, the WTRU may transmit CSI part 2 at a second MCS (608) determined using a configured, indicated or fixed association rule.

The WTRU may be configured to report CSI with resources that can fit 20 bits at QPSK modulation, e.g., 10 QPSK symbols. The WTRU may determine a CSI that has a first CSI payload equal to 10 bits or whose CSI part 2 has a payload size equal to 10 bits. Instead of reporting the CSI part 2 modulated using quadrature phase shift keying (QPSK), the WTRU may modulate the determined CSI using binary phase shift keying modulation (BPSK).

The first association rule, the second association rule, and the third association rule may be merged to a single association rule. For example, when condition-A is satisfied, using a pre-defined, configured, indicated association rule, the WTRU may jointly determine a third RS configuration, a second cod-rate, a second MCS, and/or a number of bits for bit-padding.

The WTRU may be configured to report a CSI using a configured first, second, or common set of resources that can fit a second CSI payload, at a first code-rate and at a first code MCS. When the WTRU determines the CSI, e.g., it may determine that the CSI payload is equal to the first CSI payload. Instead of reporting the determined CSI with a first CSI payload, modulated at a first MCS and transmitted at a first code-rate with a first number of bit-padding bits, the WTRU using an association rule that may be semi-statically or dynamically, explicitly or implicitly configured or indicated to the WTRU, may determine that it can send or transmit or report the CSI with a first CSI payload but modulated at a second MCS, a second code-rate and a second number of bit-padding bits. The WTRU may determine a second code-rate, a second MCS, a third RS configuration, a second set of parameter values for CSI or NZ coefficients quantization in such a way to minimize the number of bit for bit-padding.

The WTRU may utilized resources to facilitate CSI reporting. The WTRU may use a first set of resources for one or more of the following. The WTRU may use a first set of resources to send an indicator to indicate the determined rank value (e.g., Rank1). The WTRU may use a first set of resources to send an indicator to indicate the second number of NZ coefficients. The WTRU may use a first set of resources to send a first RS based on the first RS configuration

The WTRU may use a second set of resources for at least one of the following. When condition-A is not satisfied, the WTRU may use a second set of resources to send indicator(s) to indicate the remaining CSI(s) using the first code-rate, the first MCS, and/or quantized using the first set of quantization parameter(s), e.g., the actual NZ coefficients associated with the second number of NZ coefficients and/or other report quantite(s) (if configured). When condition-A is not satisfied, the WTRU may use a second set of resources to send a second RS(s) based on the second RS configuration.

When condition-A is satisfied, the WTRU may use a second set of resources to send indicator(s) to indicate the remaining CSI with a second code-rate, a second MCS, and/or a second set of CSI quantization parameter(s) that are determined using one or more of the configured association rule(s). When condition-A is satisfied, the WTRU may use a second set of resources to send a third RS(s) based on the determined third RS configuration.

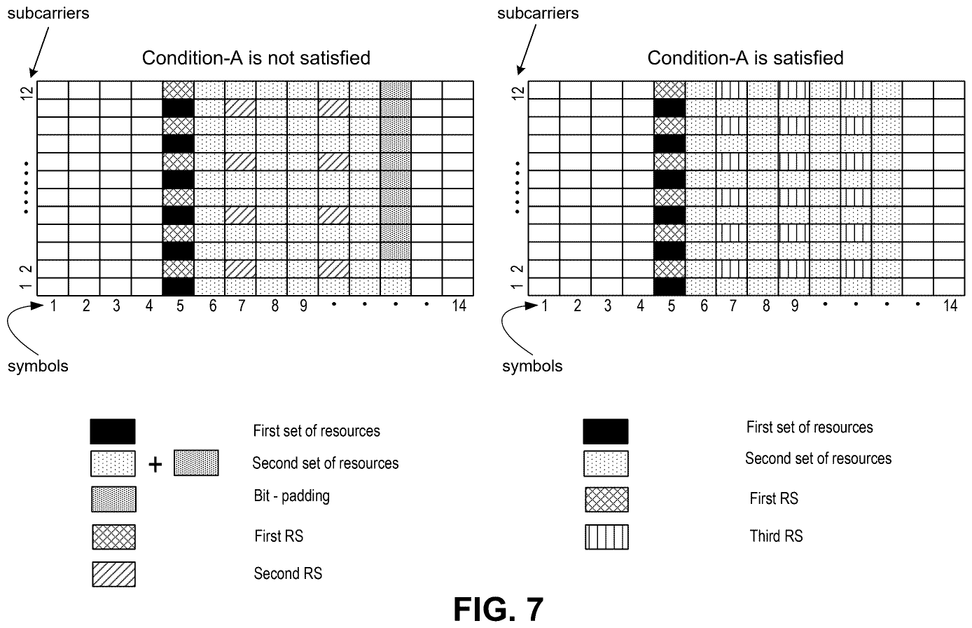

FIG. 7 is an example depiction of time and/or frequency resource utilization for CSI and reference signal (RS) transmissions. For sending the determined CSIs, the WTRU may send a CSI report to the network node). The WTRU may do one or more of the following when reporting CSIs or when sending CSI reports to the network node. Throughout this section, for the sake of explanation, it has been assumed that the first set of uplink resources are the 12 subcarriers assigned at the 5th symbol. The second set of resources are all the subcarriers at symbols 6, 7, 8, 9, 10, 11, and 12, as depicted in FIG. 7.

The WTRU may partition the determined CSIs or the determined report quantities into different parts, group, or sections based on the configured or indicated configuration or method, or based on a fixed pre-defined method. The WTRU may partition the determined CSI into two parts, e.g., CSI part 1 and CSI part 2. CSI part 1 may include RI, the second number of NZ coefficients, that indicates the number of NZ coefficients that the WTRU will report in CSI part 2. The WTRU may report the number of entities, e.g., the number of selected TRPs, selected number of panels.

The WTRU may send an indicator using the first set of uplink resources to indicate the determined RI value, for example, using the subcarriers 1 and 3 at symbol 5 the WTRU sends an indicator indicating RI.

The WTRU may send an indicator using the first set of resources to indicate the second number of NZ coefficients, for example, using the subcarriers 5, 7, 9, and 11 and 3 at symbol 5 the WTRU may send an indicator indicating the second number of NZ coefficients.

The WTRU may send the first RS using the first RS configuration, for example, using the subcarriers 2, 4, 6, 8, 10, and 12 the WTRU may send the first RS.

When condition-A is not satisfied, the WTRU may determine the number of bits needed for bit-padding. For example, X number of bits may be used for bit-padding. The WTRU may identify the resources to be used for transmission of the bit-padding bits. For example, the X number of bits requires the last 10 subcarriers at symbol 12. The WTRU may send indicator(s) to indicate the CSI contents of CSI part 2 at a first code-rate, first MCS, and/or quantized using the first set of quantization parameter(s), e.g., the actual NZ coefficients associated with the second number of NZ coefficients and/or other report quantite(s) (if configured), e.g., CQI. The WTRU mays send the second RS based on the second RS configuration using the second set of resources.

When condition-A is satisfied, using one or more of the association rules, the WTRU may determine a second code-rate, a second MCS, a second set of quantization parameters, a second rule for coefficients quantization, a number of bits for bit-padding, and/or a third RS configuration etc. The WTRU may send the remaining CSI, other parameters, or other report quantities and bit-padding bits if any using the second set of resources. For example, second RS configuration may have 8 number of second RS symbols. Based on second RS configuration, locations of the 8 second RS symbols are subcarriers 2, 5, 8, and 11 at symbols 7 and symbol 10. The third RS configuration may have 18 number of third RS symbols. Based on the third RS configuration, locations of the 18 third RS symbols are subcarriers 2, 4, 6, 8, 10, and 12 at symbols 7, 9, and 11.

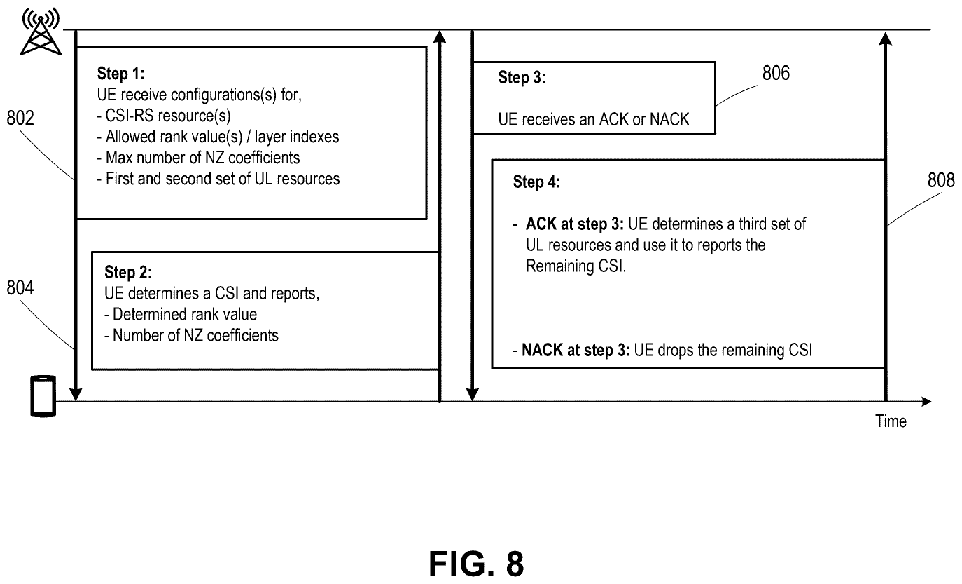

FIG. 8 is a depiction of an overview of example CSI reporting in multiple steps. Multi-step CSI reporting is described below, wherein the described mechanisms enable the network node to use the redundant resources. At step 1 (802), the WTRU may receive a semi-static or dynamic (e.g., by RRC, MAC-CE, and/or DCI) configuration and/or indication that indicates a first and second set of uplink resources for reporting CSI. The first set of uplink resources and the second set of uplink resources may be in the same slot or in different slots. The first set of resources may be the 12 subcarriers at the first symbol in a first slot, e.g., as shown in FIG. 7. The second set of resources may be the 24 subcarriers at the last two symbols in a first slot. The second set of resources may be the 24 subcarriers at the first two (or last two) symbols in a second slot.

The WTRU may determine a CSI and reports at step 2 (804). Using the first set of uplink resources, the WTRU may send indicators to indicate the RI, second number of NZ coefficients and/or a first RS. The RI and the second number of NZ coefficients may serve as an indication of the payload size of CSI part 2. Upon reception of CSI part 1, the WTRU may receive an indication, e.g., an ACK or NACK. Along with ACK or NACK. The WTRU also may receive an indication that indicates a correction to the assigned uplink resources for reporting of CSI part 2. For example, the WTRU may receive an indication that out of the assigned R number of RBs for reporting CSI part 2, only use R_sub out of R number of RBs for reporting CSI part. Alternatively, there may not be any need of network node indicating R_sub to the WTRU as R_sub can be determined by the WTRU based on the determined RI and/or the second number of NZ coefficients.

The WTRU may receive an ACK or NACK at step 3 (806). When the WTRU receives an ACK, the WTRU may report, at step 4 (808), the contents of CSI part 2 using a subset of the second set of resources, e.g., only the R_sub out of the assigned R resources are used for reporting CSI part 2. When the WTRU receives a NACK, at step 4 (808), the WTRU may drop reporting the contents of CSI part 2.

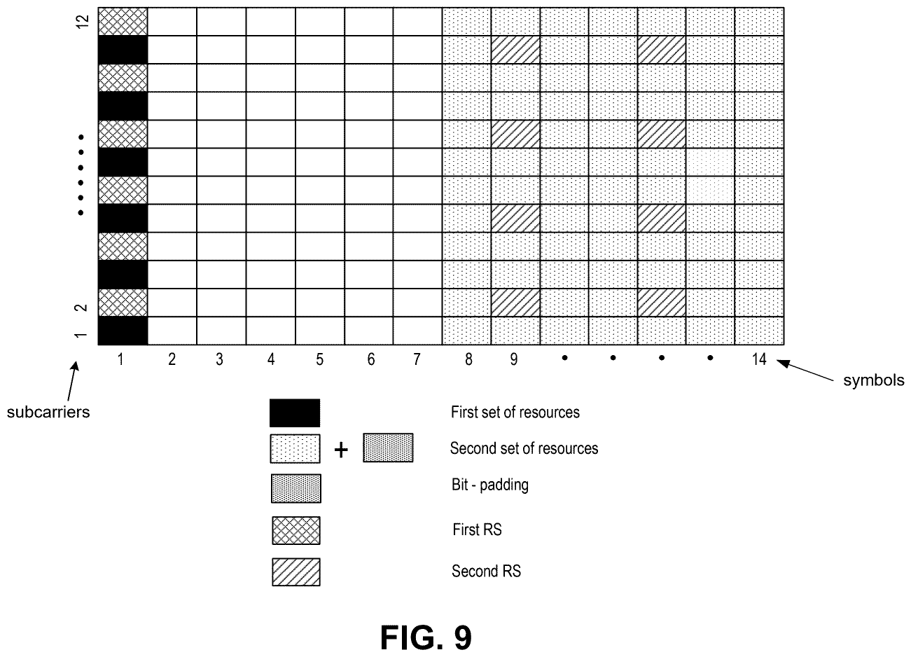

FIG. 9 is an example depiction of first and second sets of uplink resources. When the second set of uplink resources occupies one or more of the last symbols in a slot, and when the WTRU receives a NACK, the WTRU and the network node may assume that the slot in which CSI part 2 was supposed to be reported ends at the first symbol before the first symbol of the second set of uplink resources. For example, the first set of uplink resources as depicted in FIG. 9, are at symbol 1. The second set of uplink resources are at symbols 8, 9, 10, 11, 12, 13, and 14. The WTRU may receive an indication at slot 5 that indicates a NACK. Upon receiving the NACK, the WTRU may assume that symbols 8, 9, 10, 11, 12, 13, and 14 are not used for any transmission for energy saving purposes. Both the WTRU and the network node may assume that the slot ends at symbol 7.

The WTRU may be configured with one or more rules that define timing and/or frequency domain linkage for reporting of CSI part 1 and CSI part 2. For example, the WTRU may report CSI part 1 in a first symbol of slot 1. Based on a configured or indicated rule, the WTRU may report CSI part 2 in the first symbol of slot 2. Using the rule, the network node knows that CSI part 1 received at the first symbol of slot 1 and CSI part 2 received at the first symbol of slot 2 belongs to the same CSI report. Alternatively, a dedicated uplink channel may be used for linkage reporting of CSI part 1 and CSI part 2.

The WTRU may be configured for a list of uplink resources, e.g., a pool of PUCCH resources. For example, the pool of uplink resources includes a first set of resources, a second set of resources, and a third set of resources. Based on the determined RI, or the determined second number of NZ coefficients or based on the determined or selected number of entities, the WTRU selects one of the resources set in the pool of resources for CSI reporting. For example, the uses first resources set when the RI=1, the second set of resources when RI=3 and the third set of resources when RI=2.

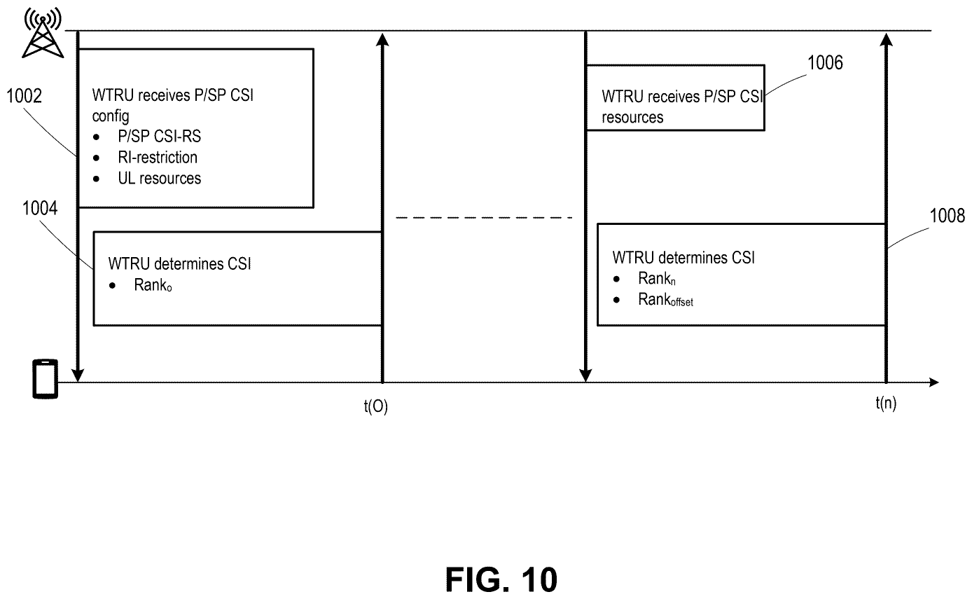

FIG. 10 is an example depiction of using the determined rank value and previously reported rank values as implicit WTRU assistant information for efficient utilization of uplink (UL) resources. WTRU assistant information may be utilized to re-adjust UL resources/RI-restrictions. As depicted in FIG. 10, a WTRU may receive CSI-RS configuration (1002), e.g., periodic or semi-persistent CSI-RS configuration, measurement restriction e.g., RI-restriction, and UL resources for CSI reporting. The WTRU may determine a CSI (1004) that may include a rank value, e.g., Rank_0. At time zero t(0), the payload may be more than needed for reporting the determined CSI. Thus, the WTRU may perform bit-padding. When the WTRU determines a CSI at t(1), e.g., the next instance in the periodic instance, the WTRU may use resources that can fit a CSI payload (1006) generated by a rank value Rank_0 that was reported at the previous reporting instance, e.g., at t(0). At t(1), the network node may expect that the WTRU will use resources that can fit a payload size generated by the rank value, i.e., Rank_0 reported at t(0). In more general terms, at reporting instance tₙ, the reported rank, i.e., rank_n is less than or equal to the rank value reported at tₙ₋₁, e.g., rankₙ≤rankₙ₋₁ and the resources used at reporting instance tₙ are such that they can fit a payload size generated by the rank value reported at tₙ₋₁. At tₙ, the WTRU may determine that the best rank is rank_{actual}. The WTRU may send an indication (1008) that indicates a rank offset, i.e., rank_{offset}, where rank_{actual}=rankₙ+rank_{offset}. In response, the WTRU may receive an indication that indicates a confirmation of using the extra resources for reporting a CSI that has a payload size which is a function of rank_{actual}. An example of WTRU behavior is depicted in FIG. 10.

For example, when the channel is in deep fade, e.g., the rank of the channel is low for a longer duration (e.g., low rank value in the case of periodic/semi-persistent CSI-RS and/or periodic/semi-persistent CSI reporting) and the network node allows a higher rank value using the RI-restriction, in one or more of the CSI reporting instances, the WTRU may do the following.

At a CSI reporting instance t(1), the WTRU may send an indication that indicates that the WTRU will release the redundant resources after the CSI reporting instance t(1), e.g., at CSI reporting instance t(2), the WTRU will not use the redundant resources. The number of redundant resources may be determined based on the rank value reported at the CSI reporting instance t(1).

At reporting instance t(2), the rank value to be reported, i.e., rank_t(2) must be less than or equal to the rank value reported at instance t(1), i.e., rank_t(2)≤rank_t(1). If the optimal rank value at reporting instance t(2) is better than rank_t(1), the WTRU may send an indication that indicates that the an even better rank value, i.e., rank_t(2)_opt is available that equal rank_t(2)_opt=rank_t(2)+delta(t2), the UE reports delta(t2). Delta(t2) may be a positive value or a negative value. If at t(2), delta≠0, the WTRU expects to receive a correction of the uplink resources.

Described below is example WTRU behavior when cell-specific and WTRU specific entity restrictions are configured. For MIMO operation, a WTRU may be instructed to restrict its scheduled downlink transmission, as well as its measurement to a certain number of layers. For example, in NR, a WTRU may be configured to a specific maximum number of layers for downlink transmission in a BWP in a WTRU-specific or cell-specific manner. For the case of WTRU-specific configuration, a WTRU may be configured with a maximum number of MIMO layers for a given BWP. In the absence of a WTRU-specific configuration, a WTRU may follow the maximum number of layers that is configured for the cell.

For a configured maximum number of MIMO layers, to reduce the CSI feedback overhead, a WTRU may receive further instruction to restrict the CSI report to only some ranks of interest, e.g., through rank restriction information (ri-restriction). However, even with such provision, the size of the CSI feedback overhead follows the maximum rank indicated by ri-restriction parameter. As such, if the WTRU is to report CSI for ri<rmax, then since its corresponding CSI payload will be smaller than allocated resource for supporting rmax, the WTRU must zero-pad its CSI content to match the size of the allocated resource.

A WTRU may avoid using unnecessary resources by appropriation of the size of the resource for CSI report according to the information indicated in rank restriction configuration. As demonstrated in the exemplary procedure in FIG. 8, a WTRU may perform one or more of the following steps. The WTRU may receive configuration(s) for one or more of the WTRU-specific and/or cell specific max MIMO layer, WTRU-specific and/or cell specific rank restriction information, and/or CSI configuration. CSI configuration information may include at least one of CSI-RS resource(s), CSI quantity, e.g., combination of rank, CQI, PMI, etc., other CSI restrictions, e.g., max number of NZ coefficients, etc., and/or CSI reporting resources, e.g., a first and a second set of UL resources based on PUCCH, PUSCH, etc.

A WTRU may be indicated a first and a second set of indications, including one or more of indices to point to a time/frequency resource, e.g., an index for the starting symbol (slot), and an index for the starting RB for each of a first and a second CSI parts. Further, the WTRU may receive an indication of M1 and M2 values (e.g., in REs) as the considered size of resources for the first and second CSI parts, respectively.

Based on at least the configured/indicated maximum number of MIMO layers (WTRU-, cell-specific) and rank restriction information, the WTRU may perform CSI measurements on the configured CSI resources. The WTRU may estimate at least the transmission rank. The WTRU may also determine other CSI components that may require a large payload size, e.g., the number of non-zero coefficient for reporting of beamforming/precoding information in NR Type-II CSI.

If the estimated rank is less than the max rank indicated by the rank restriction information, the WTRU may report only the first CSI part according to the configured time/frequency resource, e.g., time/frequency indication and M1.

Following the reporting of the first CSI part, if a WTRU receives an indication of M2_new (as the correction of the M2) before the scheduled transmission for reporting of the second CSI part, the WTRU may report the second CSI part according to the recently indicate M2_new value.

Besides M2_new, a WTRU also may receive a new indication of time/frequency resources for reporting of the second CSI. Therefore, the WTRU may report the second CSI part according to the M2_new value and the recently indicated resources. If a WTRU does not receive any indication of M2_new, the WTRU may report the second CSI part according to the original indicated M2 value.

If the estimated rank is the max rank indicated by the rank restriction information, the WTRU may report the first and second CSI parts according to the configured reporting resources, e.g., time/frequency indications and M1 and M2.

Rank restriction and first number of NZ coefficients may be implicitly indicated. The rank restriction, the set of allowed rank value, the allowed number of NZ coefficients may be implicitly indicated to the WTRU based on the assigned UL resources. For example, the network node may assign resources to the WTRU. The WTRU may determine that the assign resources may be used for reporting a maximum CSI payload generated by a rank value RI=4, and/or and by a number of NZ coefficients, e.g., a second number of NZ coefficients at a given code-rate and/or at a given MCS. The assigned resources with the configured code-rate and MCS therefore may serve as an implicit indication of the rank restriction and/or number of NZ coefficients restriction.

When two or more number of entities, e.g., layers, sub-bands, TRPs etc., generates the same payload, the WTRU may assume the minimum or the maximum number of entities, e.g., rank values, TRPs, sub-bands, layers etc., that may be restricted.

The WTRU may determine that the network node has assigned resources that can fit a maximum payload size being generated by layer 3 and layer 4. Since layer 3 and layer 4 generate the same CSI payload, the WTRU may assume that the rank restriction is 4, that is the maximum allowed rank value is 4.

Regarding dynamic entity restriction, a WTRU may receive a semi-static and/or a dynamic (e.g., by RRC, MAC-CE, and/or DCI) configuration and/or indication that may restrict one or more entities, e.g., a layer, a TRP, and/or rank value. A max rank value and a min rank value may be RRC configured. The WTRU may receive a DCI that includes a new or an existing field that indicates a rank value within the min rank value and the max rank value.

The WTRU may receive a DCI that includes an existing or a new field that indicates a rank value, one or more-layer indexes, one or more TRP indexes, or one or more entities indexes. The WTRU may treat the indicated rank values, layer indexes or entity indexes as restricted entities. For example, the WTRU may not select the indicated entities. Alternatively, the WTRU may treat the dynamically entities indexes as allowed entities.

Spatial resources may be reassigned carrier aggregation. A WTRU may be operating in a carrier aggregation scenario, wherein a first set of antenna ports may be used on the first carrier and a second set of antenna ports may be used on the second carrier. In a carrier aggregation mode, the WTRU may receive a single entity restriction indication that may be applicable to both carriers. The WTRU may receive a single indication that indicates a rank value. The indicated restricted rank value is applicable to both carriers. For example, the WTRU may receive a single indication that indicates a rank value for a first carrier. For the second carrier, the WTRU may determine the restricted rank value based on the restricted rank value for the first carrier and based on the transmit antenna ports and receive antenna ports of the second layer.

The network node may reassign one or more antenna ports from a second carrier to a first carrier. The WTRU may be pre-configured for entities restriction, e.g., the first carrier has a pre-configured or indicated allowed rank values equal to RI=2. Upon re-assignment of the spatial resources from the second carrier to the first carrier, the WTRU may determine the additional CSI-RS and or SRS antenna ports. Based on the additional assigned spatial resources and based on the pre-configured entity restriction, the UE may determine a new entity restriction of the first carrier.

Uplink resources for CRI-based CSI reporting may be determined. In existing systems, a BS may configure a CSI-RS resource set with Ks CSI-RS resources. Each CSI-RS resource may be indexed through an RRC configured index, the CSI-RS Resource Indicator (CRI). The WTRU may further be configured to determine a CSI based on M out of Ks CSI-RS resources. For example, for each of the selected M out of the Ks CSI-RS resources, the WTRU may determine RI, PMI, CQI, etc. For each of the Ks CSI-RS resources, the network node may configure a set of allowed rank values and/or a set of allowed layer indexes.

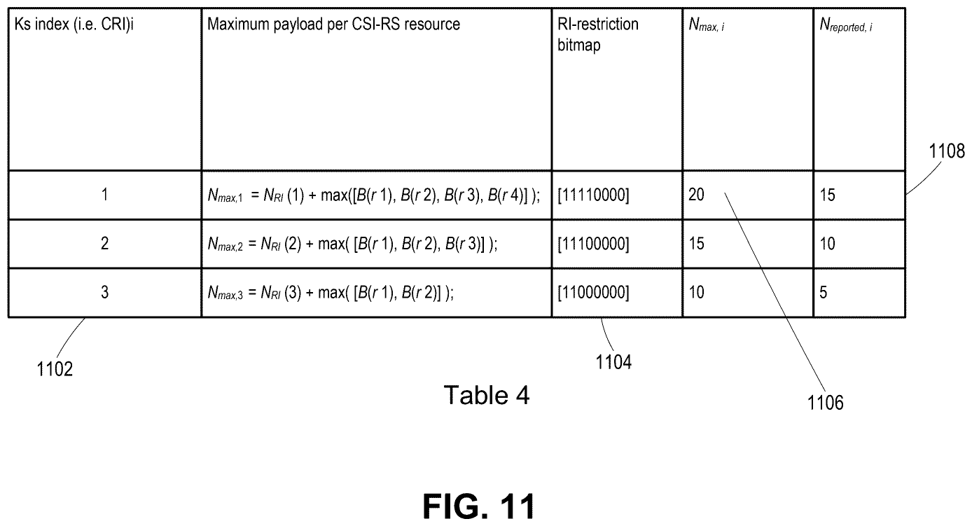

FIG. 11 depicts a table (Table 4) of an example payload with the number of channel state information reference signal (CSI-RS) resources equal to 3 (Ks=3). For Ks=3 (1102), allowed rank values and/or layer indexes are as shown in Table 4 of FIG. 11 by a RI-restriction bitmap (1104). For a selected CSI-RS resource, e.g., CSI-RS resource with index i, and when the WTRU determines a rank value based on the iₜₕ CSI-RS resource, the payload size of the CSI based on the iₜₕ CSI-RS resources then equals N_{reported,i}=N_{R}(i)+B(i), where N_{RI}(i) is the number of bits that indicates a rank value and equals N_{RI}(i)=log₂(Number of “1s” in the RI—restriction bitmap) and B(i) is the number of bits that are used for indication of the remaining report quantities, e.g., CQI, PMI, etc.

In current systems, for each of the selected M CSI-RS resources, the WTRU assumes that the number of resources for reporting CSI associated with a CRI may fit Nₘₐₓ number of bits, where:

$${N}_{max} = max ( {N}_{max , 1} , {N}_{max , 2} , … , {N}_{max , Ks} ) ,$$

where N_{max,i}=N_{RI}(i)+max([B(1), B(2), . . . , B(i)]). Alternatively, the WTRU assumes that there exist sufficient resources that can fit M*Nₘₐₓ bits, otherwise the WTRU may omit some of the CSI contents based on the specified omission rules. In summary, the WTRU can be configured to report M out of Ks CRIs with the number of bits allocated for the payload of the m'th CRI determined based on the maximum payload (Nₘₐₓ) amongst all Ks resources. In the example from Table 4 of FIG. 11, Nₘₐₓ=max(N_{max,1}, N_{max,2}, N_{max,3})=20 bits (1106). If the WTRU reports the first CRI with N_{reported,1}=15 (1108), the WTRU pads the CSI report with 20−15=5 zeros.

With this rule for payload calculation, the NW may allocate resources for the worst case (largest payload) which results in a significant amount of zero padding when there's a disparity between the RI-restriction bitmap between CRIs. For example, in the example of Table 4 of FIG. 11, the WTRU is allocated N_{max,1} bit for each of the CRIs. Since N_{max,1}=2*N_{max,3}, the WTRU always reports at least N_{max,1}-N_{max,3} zeros in the CSI resource allocation for CRI3 which is wasteful of the resources. Described below are mechanisms wherein a WTRU may determine to report additional CSI reporting quantities instead of zero padding per CRI.

A WTRU may determine to transmit multiple CSIs reporting contents associated to a single CRI. The WTRU may report two CSI reporting contents concatenated together in the resource allocation for a single CRI. The WTRU may be configured to determine CSI reporting for different measurement hypotheses associated to a single CRI. Using the example of Table 4 of FIG. 11, N_{max,1}=2*N_{max,3}. The WTRU may be configured with CRI1-3 (CSI-RS resources 1-3), and two interference measurement resources (IM1 and IM2). The WTRU may derive a first set of CSI reporting contents based on measuring CRI3 and IM1, and a second set of CSI reporting contents based on measuring CRI3 and IM2. The WTRU may report the two CSI reporting contents associated to CRI3 within the N_{max,i} resources allocated for CRI3. The NW may configure the different measurement hypotheses for e.g. multi-TRP reporting (NC-JT, CJT) where different interference assumptions are used on IM1 and IM2. Alternatively, the different hypotheses may be configured as subconfigurations of CSI reporting (e.g., similar to NES CSI subconfigurations where each subconfiguration is associated to a number of antenna elements/ports, CSI-RS power offset, etc.).

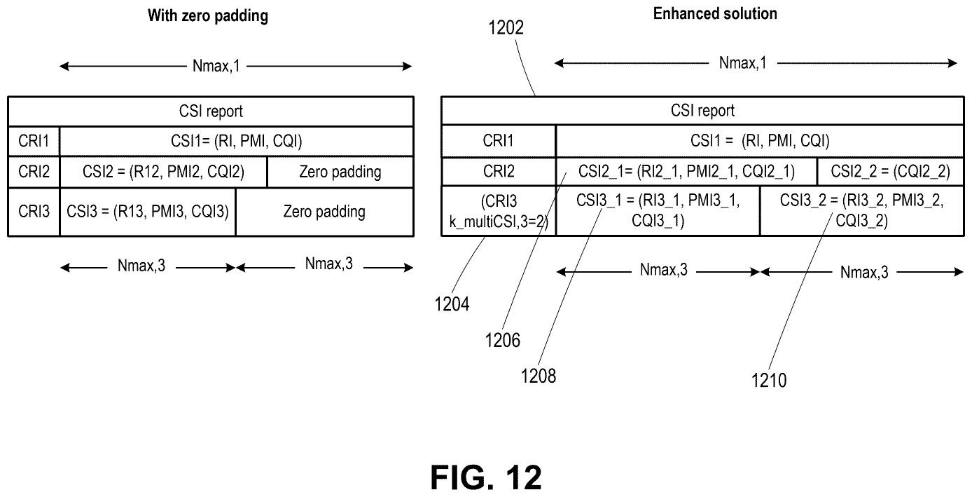

FIG. 12 is an example depiction of enhanced WTRU behavior in terms of CSI reporting when condition-A is satisfied. As depicted in FIG. 12, a WTRU may multiplex two CSI reports (see CSI report 1202) in the space allocated for CSI reporting associated to CRI3. If Nₘₐₓ>k_{multiCSI,i}*N_{max,i} for an integer k_{multiCSI,i}≥2, then there are sufficient payload bits at CRI i to multiplex k_{multiCSI,i} CSI reporting contents. For each CRI i that satisfies this relationship, the WTRU may be configured with an explicit indicator (e.g., bits) in the CSI report where the WTRU may use the indicator to signal how many CSIs are reported for CRI i. As depicted FIG. 12, the WTRU indicates that it multiplexes 2 CSI reports for CRI3 (1204). If the WTRU indicates only 1 CSI report, then the WTRU may pad the remaining resources with zeros. Alternatively, the WTRU may be implicitly configured with the number of CSIs to report. For example, the WTRU may be configured with a number of hypotheses (e.g., IM resources) per CRI, and the WTRU may determine that the number of CSIs for CRI i is equal to the number of hypotheses configured.

In FIG. 12, an alternative solution for CRI2 is depicted (1206). If the WTRU cannot multiplex multiple CSIs for one CRI (e.g., k_{multiCSI,i}<2), the WTRU may be configured to report a partial CSI with an additional CSI reporting quantity to report for a second hypothesis where one or more of the reporting quantities from the primary CSI are reused for determining the partial CSI. For example, for CRI2, the WTRU may be configured to report one primary CSI (CSI2_1) with the reporting quantities RI2_1, PMI2_1, and CQI2_1. The WTRU may also be configured to report a partial CSI (CSI2_2) with the reporting quantity (CQI2_2), where the WTRU may determine CQI2_2 assuming RI2_1 and PMI2_1. The WTRU may be configured with two hypotheses (e.g., IM resources) for CRI2, and the UE derives the primary CSI based on the first hypotheses (e.g., IM1), and the partial CSI based on the second hypotheses (e.g., IM2) assuming RI_2,2 and PMI2_1.

The WTRU may multiplex colliding CSI reports into a single report instead of dropping one of the reports (e.g., based on priority rule) where the WTRU may multiplex the CSI onto the zero padded bits. This rule may be applied if the WTRU determined CSI reporting quantities for a same CRI in both colliding reports. Then, the resources of the multi-CRI reporting payload of the corresponding CRI may be reused for multiplexing. Two CSI reports collide if the WTRU is scheduled/triggered to report two CSI reports on time/frequency resources which partially or completely overlap. For example, a WTRU may be configured with a first periodic CSI report with reporting contents as a function of CRI3. The WTRU may be triggered with a second CSI report for multi-CRI reporting (e.g., aperiodic CSI report) which may be scheduled to report on a slot (e.g., PUSCH) where the WTRU is already supposed to report the periodic CSI. The WTRU may multiplex the periodic CSI report instead of the zero padding bits of the associated CRI payload content.

Referring to FIG. 12, CSI3_1 (1208) may correspond to the WTRU's CSI report based on the triggered aperiodic CSI report, and CSI3_2 (1210) may correspond to the multiplexed periodic CSI report that collided. The WTRU may determine to use this feature if the network configures a joint multiplexing mode of CSI reporting. If the joint multiplexing mode is not configured, the WTRU may prioritize the transmission of one of the two CSI report based on existing priority rules, and drop the report with the e.g. lowest priority.

In the current systems, for each of the selected M CSI-RS resources, a WTRU assumes that the resources for reporting CSI associated with a CRI may fit Nₘₐₓ number of bits, where,

$${N}_{max} = max ( {N}_{max , 1} , {N}_{max , 2} , … , {N}_{max , Ks} ) ,$$

where N_{max,i}=N_{RI}(i)+max([B(1), B(2), . . . , B(rᵢ)]), where rᵢ is the maximum allowed rank value and where N_{RI}(i)+B(rᵢ) is the payload size generated by the CSI when the selected rank value is rᵢ. Alternatively, the WTRU assumes that there exist sufficient resources that can fit M*Nₘₐₓ bits, e.g., based on the assumed Kₛ=3 and M=2, the gNB assigns sufficient uplink resources that can be used for transmission of 2*20 bits (e.g., at a code-rate of 1 and BPSK modulation), otherwise the UE may omit some of the CSI contents based on the specified omission rules. To reduce resources for CSI reporting or to reduce the wastage of resources, the following solution is proposed.

The network node may assign resources to the WTRU for reporting CSI based on the configured value of M and based on the M CRIs that has the related N_{max,i} values. For example, the network node knows that N_{max,1}=20 and N_{max,2}=15 and N_{max,3}=10. Therefore, the network node instead of assigning resources that can transmit M*Nₘₐₓ=40 bits, assigns sufficient resources that can fit N_{max,1}+N_{max,2}=35 bits.

The WTRU may determine or select M CRIs and determines CSI on the selected CRIs. For example, the WTRU may select CRI1 and CRI3. For CRI1, the WTRU may determine a rank value equal to 3. Rank value equal to 3 on CRI1 generates a payload size equal to N_{reported,1}=11 bits. For CRI3, the WTRU may determine a rank value equal to 1. Rank value equal to 1 on CRI3 generates a payload size equal to N_{reported,3}=7 bits.

Based on the legacy assumption, the WTRU is required to add the following number of bits for bit-padding. For CRI1, the WTRU adds O_{P,1}=Nₘₐₓ−N_{reported,1}=20−11=9 bits. For CRI3, the WTRU adds O_{P,3}=Nₘₐₓ−N_{reported,3}=20−7=13 bits.

The WTRU may identify the CRI with the highest N_{reported,i} value, e.g., CRI(1) with N_{reported,1}=11 bits. For CRI(1), the UE determines the number of bits for bit-padding as O_{P,1}=Nₘₐₓ−N_{reported,1}=20−11=9 bits. Then, the WTRU may identify the CRI with the second highest N_{max,i} value, e.g., CRI(2) with N_{max,2}=15 bits. Then, the WTRU may identify the second selected CRI (which in the considered example is CRI(3)) with the second highest N_{reported,i} value, e.g., CRI(3) with N_{reported,3}=7 bits. For the second selected CRI, the WTRU may determine the number of bits for bit-padding as, O_{p,3}=N_{max,2}−N_{reported,3}=15−7=8 bits. Based on the following example, it can be observed that the WTRU uses resources that can report 11+9+7+8=35 bits. As observed, the proposed method can save resources for reporting CSI.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media (which do not include transitory signals). Examples of computer-readable storage media, which are differentiated from signals, may include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, network node, base station, RNC, or any host computer.

Any of the operations, processes, etc. described herein may be implemented as computer-readable instructions stored on a computer-readable storage medium. The computer-readable instructions may be executed by a processor of a mobile unit, a network element, and/or any other computing device.

What is claimed is:

1. A wireless transmit/receive unit (WTRU) comprising:
a transceiver; and
a processor configured to:
receive, via the transceiver, configuration information, the configuration information comprising first uplink transmission parameters, a first uplink resource set, second uplink transmission parameters, a second uplink resource set, and an indication of association rules;
determine a size of a first channel state information (CSI) payload and a size of a second CSI payload;
based on a determination that the size of the first CSI payload is less than the size of the second CSI payload, determine third uplink transmission parameters based on the association rules;
send, via resources indicated by the first uplink resource set, a first uplink transmission using the first uplink transmission parameters, wherein the first uplink transmission comprises the first CSI payload; and
send, via resources indicated by the second uplink resource set, a second uplink transmission using the third uplink transmission parameters, wherein the second uplink transmission comprises the second CSI payload.

2. The WTRU of claim 1, wherein, based on a determination that the size of the first CSI payload is equal to or greater than the size of the second CSI payload, the processor is configured to send, via the resources indicated by the second uplink resource set, the second uplink transmission using the second uplink transmission parameters, wherein the second uplink transmission comprises the second CSI payload.

3. The WTRU of claim 1, wherein the third uplink transmission parameters comprise a reference signal configuration, a code-rate, and a set of CSI quantization parameters for sending the second uplink transmission.

4. The WTRU of claim 3, wherein the reference signal configuration comprises a Demodulation Reference Signal (DMRS) configuration.

5. The WTRU of claim 1, wherein the first uplink transmission parameters comprise a first reference signal configuration, a first code-rate, and a first set of CSI quantization parameters for sending the first uplink transmission;
wherein the second uplink transmission parameters comprise a second reference signal configuration, a second code-rate, and a second set of CSI quantization parameters for sending the second uplink transmission when the size of the first CSI payload is equal to or greater than the size of the second CSI payload; and
wherein the third uplink transmission parameters comprise a third reference signal configuration, a third code-rate, and a third set of CSI quantization parameters for sending the second uplink transmission when the size of the first CSI payload is less than the size of the second CSI payload.

6. The WTRU of claim 1, wherein the processor is configured to determine a number and locations of symbols of the third uplink transmission parameters based on the association rules.

7. The WTRU of claim 1, wherein:
the size of the first CSI payload is based on a first rank value; and
the size of the second CSI payload size is based on a second rank value.

8. The WTRU of claim 7, wherein the processor is configured to:
determine the first rank value; and
receive, via the transceiver, the second rank value.

9. The WTRU of claim 1, wherein the third uplink transmission parameters comprise a precoding matrix indicator (PMI).

10. The WTRU of claim 1, wherein the processor is configured to determine a number of bits for bit padding the third uplink transmission based on the association rules.

11. The WTRU of claim 1, wherein the processor is configured to determine a number of non-zero coefficients of the second uplink transmission based on the association rules.

12. A method performed by wireless transmit/receive unit (WTRU), the method comprising:
receiving configuration information, the configuration information comprising first uplink transmission parameters, a first uplink resource set, second uplink transmission parameters, a second uplink resource set, and an indication of association rules;
determining a size of a first channel state information (CSI) payload and a size of a second CSI payload;
based on a determination that the size of the first CSI payload is less than the size of the second CSI payload, determining third uplink transmission parameters based on the association rules;
sending, via resources indicated by the first uplink resource set, a first uplink transmission using the first uplink transmission parameters, wherein the first uplink transmission comprises the first CSI payload; and
sending, via resources indicated by the second uplink resource set, a second uplink transmission using the third uplink transmission parameters, wherein the second uplink transmission comprises the second CSI payload.

13. The method of claim 12, wherein the third uplink transmission parameters comprise a reference signal configuration, a code-rate, and a set of CSI quantization parameters for sending the second uplink transmission.

14. The method of claim 13, wherein the reference signal configuration comprises a Demodulation Reference Signal (DMRS) configuration.

15. The method of claim 12, wherein the first uplink transmission parameters comprise a first reference signal configuration, a first code-rate, and a first set of CSI quantization parameters for sending the first uplink transmission;
wherein the second uplink transmission parameters comprise a second reference signal configuration, a second code-rate, and a second set of CSI quantization parameters for sending the second uplink transmission when the size of the first CSI payload is equal to or greater than the size of the second CSI payload; and
wherein the third uplink transmission parameters comprise a third reference signal configuration, a third code-rate, and a third set of CSI quantization parameters for sending the second uplink transmission when the size of the first CSI payload is less than the size of the second CSI payload.

16. The method of claim 12, wherein:
the size of the first CSI payload is based on a first rank value; and
the size of the second CSI payload size is based on a second rank value.

17. The method of claim 12, further comprising determining a number and locations of symbols of the third uplink transmission parameters based on the association rules.

18. The method of claim 16, further comprising:
determining the first rank value; and
receiving the second rank value.

19. The method of claim 12, further comprising determining a number of bits for bit padding the third uplink transmission based on the association rules.

20. The method of claim 12, further comprising determining a number of non-zero coefficients of the second uplink transmission based on the association rules.
